(19) United States
(12) Patent Application Publication
(10) Pub. No.: US 2017/0147459 A1
(43) Pub. Date: May 25, 2017

(54) AVAILABILITY ANALYSIS DEVICE, AVAILABILITY ANALYSIS METHOD, AND RECORDING MEDIUM HAVING AVAILABILITY ANALYSIS PROGRAM RECORDED THEREIN

(71) Applicant: NEC Corporation, Minato-ku Tokyo (JP)

(72) Inventor: Fumio MACHIDA, Tokyo (JP)

(73) Assignee: NEC Corporation, Minato-ku, Tokyo (JP)

(21) Appl. No.: 15/129,919

(22) PCT Filed: Apr. 16, 2015
(86) PCT No.: PCT/JP2015/002092

§ 371 Date: Sep. 28, 2016

(30) Foreign Application Priority Data
Apr. 16, 2014 (JP) 2014-084087

(51) Int. Cl. G06F 11/22; G06F 11/07; G06N 7/00

(52) U.S. Cl. CPC G06F 11/22; G06N 7/005; G06F 11/0766

(57) ABSTRACT

Provided is an availability analysis device and the like capable of analyzing availability even when a system of interest is large. An availability analysis device (151) includes an analysis unit (152) that: calculates a value concerning an interval between two states included in a plurality of states on the basis of (I) component information representing a transition rate in the interval between states of components included in a system of interest, (II) defect information including a condition representing a component state in the case of a defect state representing a state in which, among a plurality of possible states of the system of interest, the system of interest cannot operate, and (III) recovery information including a transition rate in the case of transition of the system of interest from the defect state to an operating state representing a state in which the system of interest is operating; calculates a probability of the system of interest being in a certain state on the basis of the calculated value concerning the interval of the two states; and calculates availability concerning the system of interest on the basis of the probability in the case of the system of interest being in the operating state.

### TECHNICAL FIELD

The present invention relates to an availability analysis device and the like that is capable of analyzing the availability of an information processing system and the like.

### BACKGROUND ART

Availability is one of indices for quantitatively evaluating the reliability (availability for use) of an IT (Information Technology) system (hereinafter, referred to as “target system”). Availability represents a probability that the target system is in a usable state when the state of the target system transitions (changes) as the time elapses.

A provider that operates a target system calculates availability on the basis of a configuration of the target system or information representing states of the target system. The provider evaluates reliability of the target system quantitatively based on the calculated availability. Alternatively, the provider searches for a defect in the target system on the basis of the calculated availability. Alternatively, the provider creates an improvement plan on the basis of the calculated availability.

In general, availability is calculated based on a state transition model. For example, a procedure for calculating availability on the basis of a stochastic process, such as a continuous time Markov chain, includes the following steps 1 and 2. That is, the procedure includes:
(Step 1) representing state transitions related to a target system as a model, and
(Step 2) calculating a probability of that the target system is in a usable state by analyzing a stochastic process on the basis of the model.

For example, PTL 1 discloses a device that evaluate usability of a complex target system according to a Markov chain model. That is, the device generates a Markov chain model for the target system by using failure rates and recovery rates of components included in the target system. Next, the device evaluates usability of the target system by analyzing state transitions represented by the generated Markov chain model.

PTL 2 discloses a method for analyzing availability of a target system on the basis of a model representing the target system by combining a state transition model and a fault tree.

For example, a model for analyzing availability often boils down to a model based on a continuous time Markov chain as disclosed in PTLs 1 and 2 and the like. That is, availability is calculated by using a means for analyzing a continuous time Markov chain.

### CITATION LIST

### Patent Literature

PTL 1: Japanese Patent Application Laid-Open Publication No. 2003-337918
PTL 2: International Publication No. 2013/168495

### Non Patent Literature

NPL 1: P. Buchholz and P. Kemper, “Kronecker Based Matrix Representations for Large Markov Models”, Validation of Stochastic Systems, LNCS2925, pp. 263, Section 2.4, 2004.

### SUMMARY OF INVENTION

### Technical Problem

As the number of states of a target system increases, the number of transitions between states rapidly increases in accordance with combinations of those states. For example, when the number of states of a target system is N (where N is a natural number), a matrix Q representing transitions between the states has N squared elements. Thus, storing the matrix Q in a storage device causes a large quantity of memory (storage device) to be consumed.

Furthermore, when calculating availability on the basis of the matrix Q, it is required to perform multiplication between a vector having N elements and a matrix having (N×N) (where “×” denotes multiplication) elements. In consequence, the time required for calculating availability increases in proportion to N squared.

Therefore, an availability evaluation method based on state transition analysis has a problem in that analysis of a target system rapidly becomes more difficult as the number of states related to the target system increases.

Accordingly, a main object of the present invention is to provide an availability analysis device and the like that is capable of performing availability analysis even when dealing with a large-scale target system.

### Solution to Problem

In order to achieve the aforementioned object, as an aspect of the present invention, an availability analysis device including: analysis means for calculating, on basis of (I) component information representing transition rates for transition between states of each component included in a target system, (II) failure information including a condition prescribing failure states of the components in a case in which the target system is in a failure state out of a plurality of states of the target system, the failure state indicating that the target system is unable to operate, and (III) recovery information including a transition rate at which the target system transitions from the failure state to an operation state, the operation state indicating that the target system is in operation, a value related to a relation between two states included in the plurality of states, calculating, on the basis of the value related to the relation between two states thus calculated, a probability that the target system is in one of the plurality of states, and calculating, on basis of the probability that the target system is in the operation state, availability of the target system.

In addition, as another aspect of the present invention, an availability analysis method including:

calculating, on basis of (I) component information representing transition rates for transition between states of each component included in a target system, (II) failure information including a condition prescribing failure states of the components in a case in which the target system is in a failure state out of a plurality of states of the target system, the failure state indicating that the target system is unable to operate, and (III) recovery information including a transition rate at which the target system transitions from the failure state to an operation state, the operation state indicating that the target system is in operation, a value related to a relation between two states included in the plurality of states, calculating, on the basis of the value related to the relation between two states thus calculated, a probability that the target system is in one of the plurality of states, and calculating, on basis of the probability that the target system is in the operation state, availability of the target system.

Furthermore, the object is also realized by an availability analysis program, and a computer-readable recording medium which records the program.

### Advantageous Effects of Invention

An availability analysis device and the like according to the present invention makes it possible to analyze availability of a target system even when its scale is large.

### BRIEF DESCRIPTION OF DRAWINGS

FIG. 1 is a block diagram illustrating a configuration of an availability analysis device according to a first example embodiment of the present invention.

FIG. 2 is a flowchart illustrating a processing flow in the availability analysis device according to the first example embodiment.

FIG. 3 is a flowchart illustrating a processing flow in a calculation unit according to the first example embodiment.

FIG. 4 is a flowchart illustrating a processing flow in an input unit.

FIG. 5 is a diagram conceptually illustrating an example of component information.

FIG. 6 is a block diagram illustrating a configuration of an availability analysis device according to a second example embodiment of the present invention.

FIG. 7 is a flowchart illustrating a processing flow performed in the availability analysis device according to the second example embodiment.

FIG. 8 is a flowchart illustrating an example of a processing flow of generating reachability information and the like.

FIG. 9 is a block diagram illustrating a configuration of an availability analysis device according to a third example embodiment of the present invention.

FIG. 10 is a flowchart illustrating a processing flow in the availability analysis device according to the third example embodiment.

FIG. 11 is a block diagram illustrating a configuration of an availability analysis device according to a fourth example embodiment of the present invention.

FIG. 12 is a block diagram illustrating an example of a configuration of a storage system employing RAID.

FIG. 13 is a diagram conceptually illustrating an example of a continuous time Markov chain related to a storage device.

FIG. 14A is diagrams illustrating an example of a matrix Q.

FIG. 14B is diagrams illustrating an example of a matrix Q.

FIG. 15 is a diagram conceptually illustrating an example of a matrix for reachable states.

FIG. 16 is a diagram conceptually illustrating an example of a matrix that is generated when system failure states subjected to the processing are processed as a single system failure state.

FIG. 17 is a block diagram illustrating a configuration of an availability analysis device according to a fifth example embodiment of the present invention.

FIG. 18 is a block diagram schematically illustrating a hardware configuration of a calculation processing apparatus capable of realizing an availability analysis device according to each example embodiment of the present invention.

### DESCRIPTION OF EMBODIMENTS

First, to facilitate comprehension of the invention, technical terms, such as a continuous time Markov chain, will be described.

A continuous time Markov chain represents transition relations between states (hereinafter, referred to as “state of a target system”), such as a state representing a situation in which the target system is in operation and a state representing a situation in which the target system is in failure, by using an infinitesimal generator matrix (hereinafter, referred to as “matrix”) Q. The continuous time Markov chain herein is a continuous time Markov chain. The infinitesimal generator matrix herein is an infinitesimal generator matrix. Each row of the matrix Q of the continuous time Markov chain is associated with a state of the target system. Similarly, each column of the matrix Q of the continuous time Markov chain is associated with a state of the target system. A transition rate for a transition between two different states is described as a component in the matrix Q. When an average transition time is denoted by T (where T>0), a transition rate can be written as, for example, “1/T”.

For convenience of description, a target system is, for example, described by using the first to the N-th (where N is a natural number) states in a continuous time Markov chain. For example, an I-th row of a matrix Q and an I-th column of the matrix Q represent the I-th state, and a J-th row of the matrix Q and a J-th column of the matrix Q represent the J-th state. The matrix Q is a square matrix, and I satisfies 1≦I≦N. J satisfies 1≦J≦N.

In this case, an element at an I-th row and J-th column of the matrix Q represents a transition rate for a transition from the I-th state to the J-th state. An element at an I-th row and I-th column of the matrix Q is a value calculated in accordance with the definition of a continuous time Markov chain.

In example embodiments described hereinafter, it is assumed that, a state of a target system is associated with a state identifier uniquely identifying the state. It is also assumed that a state of the target system is associated with a combination of states of a plurality of components when a target system has the components. The target system includes a plurality of the components (elements). A component of them is an element (composing element) included in a target system. For example, when a target system is an information processing device, components are exemplified by a memory, a hard disk, and the like.

When a target system is a factory, components are exemplified by machines, communication devices, and the like in the factory. Hereinafter, for convenience of description, a state in which a component is in operation and a state in which the component is in failure are sometimes referred to as “component operation state” and “component failure state”, respectively. A state of a component is sometimes referred to as “component state”. A state in which a target system is in operation is sometimes referred to as “system operation state”. A state in which the target system is not operable because of a failure is sometimes referred to as “system failure state”. A state of a target system is sometimes referred to as “system state”.

Hereinafter, for convenience of description, an element at an I-th row and J-th column of a matrix Q is referred to as an (I, J) element. An (I, J) element of a matrix Q is denoted by Q(I, J).

Further, a value of Q(I, I) is defined in Eqn. 1. That is,

Q(I,I)=−(Σ_{(J≠I)}Q(I,J)) (Eqn. 1),
(where Σ_{(J≠I)} denotes that the sum is taken over J such that J≠I).

Using such a matrix Q makes it possible to analyze a continuous time Markov chain. For example, for a specific type of continuous time Markov chain, a probability vector π (numerical string π) that represents a steady state after a sufficiently long time has passed can be calculated as a solution to an equation written in Eqn. 2.

π#Q=0, π=(π₁,π₂, . . . ,π_{N}),

Σ_{I}π_{I}=1 (Eqn. 2),
(where π_{I} denotes a probability that a target system is in an I-th system state while in a steady state, Σ_{I} denotes that the total summation is taken over I as I ranges from 1 to N, and # denotes a matrix vector product).

For example, when a first system state is the only operation state related to a target system, availability of the target system that is in a steady state is π₁.

Next, example embodiments embodying the present invention will be described in detail with reference to the accompanying drawings.

### First Example Embodiment

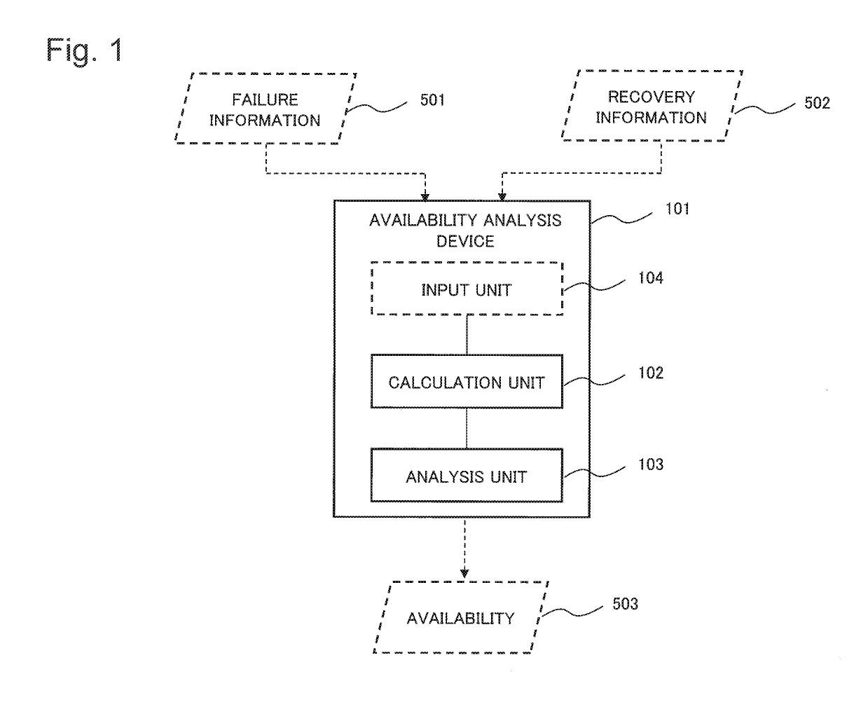

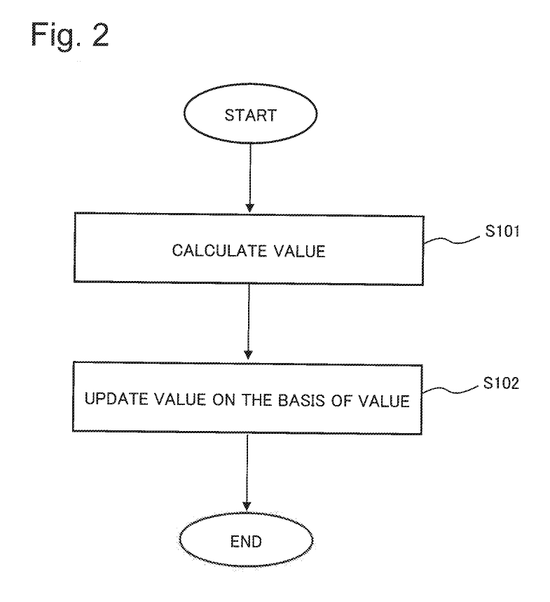

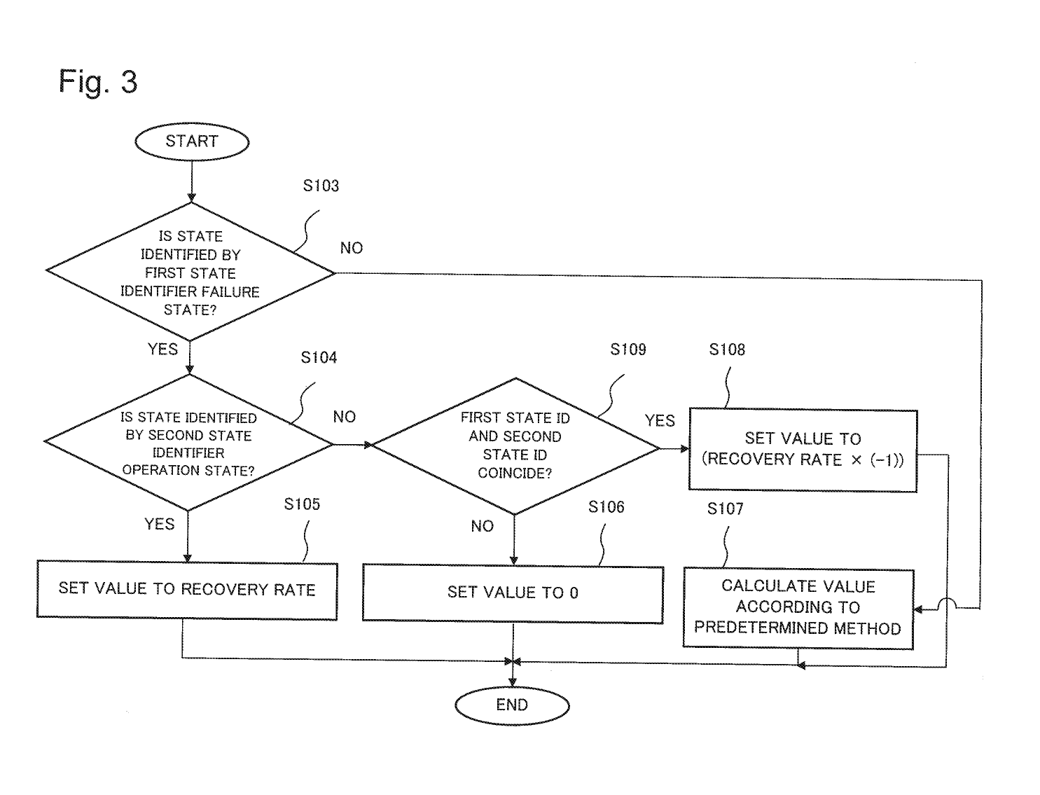

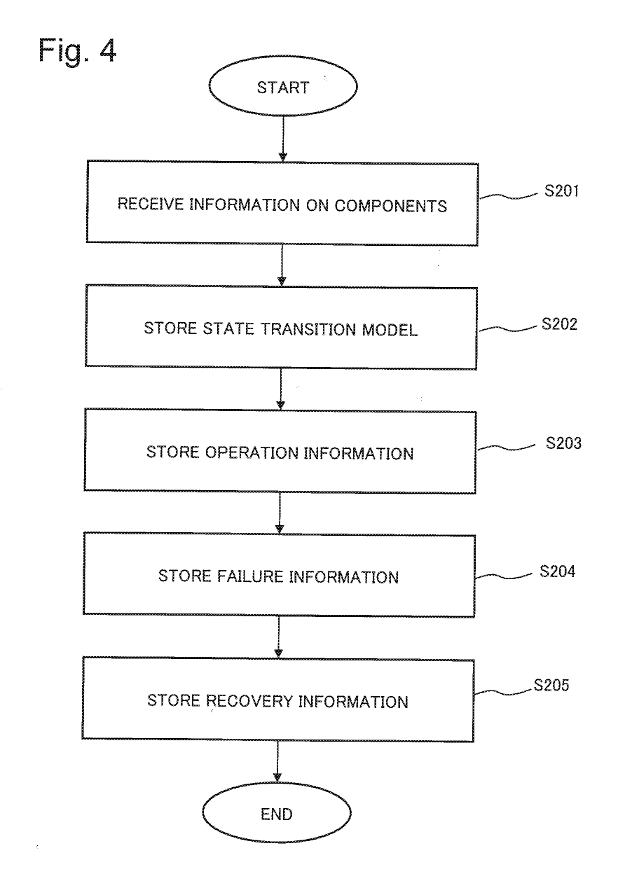

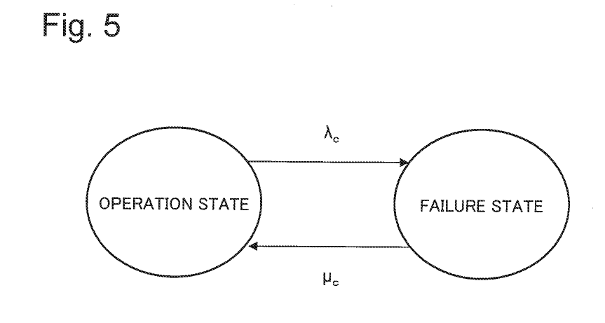

In the example embodiment, an availability analysis device will be described in the following order. A figure number to be referenced are stated in parentheses.
(1) on the configuration of the availability analysis device (FIG. 1),
(2) on processing in an input unit that the availability analysis device includes (FIG. 4),
(3) on component states of components included in a target system (FIG. 5),
(4) on a processing flow in the availability analysis device (FIG. 2), and
(5) on a processing flow in a calculation unit that the availability analysis device includes (FIG. 3).

First, with reference to FIG. 1, a configuration of an availability analysis device 101 according to the first example embodiment of the present invention will be described in detail. FIG. 1 is a block diagram illustrating the configuration of the availability analysis device 101 according to the first example embodiment of the present invention.

The availability analysis device 101 according to the first example embodiment includes a calculation unit 102 and an analysis unit 103. The availability analysis device 101 may further include an input unit 104.

Next, with reference to FIG. 4, an operation performed by the input unit 104 will be described. FIG. 4 is a flowchart illustrating a processing flow in the input unit 104.

The input unit 104 receives component information on a plurality of components in a target system that is a target for evaluating an availability 503 (step S201). The components are, for example, composing elements included in the target system. For example, when the target system is a storage system, the components are storage devices in the storage system and a control device or the like that controls the storage devices. When the target system is software, the components are functions, modules, and the like in the software.

The above description also applies to respective example embodiments, which will be described hereinafter. A piece of component information includes information on state transitions, which are defined in advance in accordance with the type of a component, as illustrated in FIG. 5. FIG. 5 is a diagram conceptually illustrating an example of the component information. The component information may include information on the plurality of components.

In the example illustrated in FIG. 5, a component is in either of two component states made up of a component operation state, which is a state in which the component is in operation, and a component failure state, that is a state in which the component has a failure. In the example illustrated in FIG. 5, λ_{c} denotes a transition rate for a component transition from the component operation state to the component failure state. That is, λ_{c} represents a transition rate (failure rate) for a component transition from the component operation state to the component failure state. Further, μ_{c} denotes a transition rate (recovery rate) of a component transition from the component failure state to the component operation state.

For example, the component information includes such information in which a first component state of a component indicates the component operation state and a second component state of the component indicates the component failure state. For example, the component information also includes a transition rate for a component transition from the first component state to the second component state. The component information also includes, for example, information on a transition rate for a component transition from the second component state to the first component state.

The input unit 104 may generate a state transition model of the target system on the basis of the received component information and store the state transition model into a storage unit (not illustrated) (step S202). In the state transition model, for example, each state of the target system is represented by a node, and each transition from a first state to a second state is represented by an edge connecting a node representing the first state with a node representing the second state. A transition rate, which indicates a degree of ease of transition between a first state and a second state, may be given to each edge. In this case, the state transition model is conceptually described by using a graph.

Next, the input unit 104 receives operation information that includes one or more operation conditions, each of which represents a condition for determining whether the target system is in a system operation state, and stores the operation information into the storage unit (not illustrated) (step S203). The operation condition is described by using component states of components included in the target system. The operation condition is, for example, represented by combining state identifiers each identifying a component state. Operation information includes one or more operation conditions.

For convenience of description, the component operation state and the component failure state are indicated by 0 and 1, respectively.

For example, the operation condition is represented as a logical sum of component states of one or more components. This means that a target system is in a system operation state when all the components included in the target system are in component operation states. When any one component out of the components is in a component failure state, the value of the operation condition becomes 1. This means that the target system is in the system failure state.

For example, an operation condition may represent whether or not the number of components in specific component states is less than a predetermined value K. In this case, the operation condition represents a condition that, “when (M-K) or more components are in component operation states, the target system is in a system operation state”. In the condition, it is assumed that M is an integer of 1 or greater and represents the number of components of the target system. Further, it is assumed that 0≦K≦M holds.

Next, the input unit 104 receives failure information including one or more failure conditions, each of which represents a condition for determining whether the target system is in a system failure state, and stores the failure information into the storage unit (not illustrated) (step S204). A failure condition is represented by using component states of components included in the target system. For example, a failure condition is represented by combining state identifiers (hereinafter, for convenience of description, also referred to as “third state identifier”) each identifying a component failure state. Failure information includes one or more failure conditions.

For example, a failure condition is represented as a logical product of components states of one or more components. This means that a target system is in a system failure state when all the components included in the target system are in component failure states.

A failure condition may represent whether or not the number of components in a specific component state(s) is greater than or equal to a predetermined value K. In this case, the failure condition represents a condition that, “when K or more components are in component failure states, the target system is in a system failure state”.

Hereinafter, for convenience of description, a description will be made assuming that the system state after recovery is a system operation state. However, the system state after recovery does not always have to be the system operation state or a system operation state before transition to a system failure state. This also applies to the respective example embodiments that will be described hereinafter.

Next, the input unit 104 receives recovery information on the target system and stores the received recovery information into the storage unit (not illustrated) (step S205). In recovery information, a failure condition, a system operation state of the target system after having recovered from a system failure state satisfying the failure condition, and a transition rate indicating a degree of ease of transition from the system failure state to the system operation state are associated with one another. A failure condition included in the recovery information may include a state identifier associated with the failure condition. As used herein, a recovery rate indicates a transition rate for a transition from a system failure state to a system operation state. As described above, a failure condition is represented by using a state identifier identifying the system failure state. Thus, a state identifier(s) representing the failure condition (that is, a third state identifier(s)), a system operation state, and a transition rate may be associated with one another in the recovery information. In the recovery information, a third state identifier, a state identifier associated with the system operation state (hereinafter, for convenience of description, also referred to as “fourth state identifier”), and a transition rate may also be associated with one another.

For example, in recovery information 502, a state (0, 0), that represents a system operation state of a target system recovered from a system failure state satisfying a failure condition A, and a transition rate for a transition from the system failure state to the system operation state are associated with each other. For example, when the target system includes a component 1 and a component 2, the failure condition A is a condition representing whether or not both the component 1 and the component 2 are in component failure states. In this case, the failure condition A represents whether or not the system state is a state (1, 1). For example, when the target system is in a system state (1, 1), which indicates that the component 1 is in a component failure state and the component 2 is also in a component failure state, the system state satisfies the failure condition A. Thus, the target system is in a system failure state. For example, a system state (1, 0) indicates that the component 1 is in a component failure state, and the component 2 is in a component operation state. Thus, the system state (1, 0) does not satisfy the condition A. Therefore, the target system is not in a system failure state.

Using an example in which availability in a steady state (steady-state availability) is obtained through numerical analysis as an example of analyzing availability, processing in the availability analysis device 101 according to the example embodiment (FIG. 2) will be described. FIG. 2 is a flowchart illustrating a processing flow in the availability analysis device 101 according to the first example embodiment. This example is an example of a continuous time Markov chain.

The analysis unit 103 calculates an index π_{I} indicating that the target system is in an I-th (where 1≦I≦N) system state while in a steady state by performing, one or more times, processing that will be described later. That is, the analysis unit 103 calculates a numerical string π=(π₁, π₂, . . . , π_{N}).

Hereinafter, for convenience of description, it is assumed that a numerical string subjected to update when the analysis unit 103 performs a k-th (where k is a natural number) round of processing is denoted by a numerical string (vector) π^{(k)}. It is also assumed that the calculation unit 102 calculates a transition rate for a transition from an I-th system state to a J-th (where 1≦J≦N) system state (that is, Q(I, J)) and, in accordance with Eqn. 1, calculates Q(I, I). However, the calculation unit 102 does not always have to calculate a transition rate itself and may calculate a value that is calculated based on the transition rate.

First, the analysis unit 103 calculates a numerical string π⁽¹⁾ in the first round of processing. The numerical string π⁽¹⁾ may be such a numerical string that only one element thereof has 1 and the other elements have 0. The numerical string π⁽¹⁾ may also be a numerical string that is calculated in accordance with a specific procedure.

Next, the analysis unit 103 calculates a numerical string π^{(k+1)} in a k-th round of processing on the basis of a numerical string π^{(k)} and on the basis of values that the calculation unit 102 calculates,

For example, the analysis unit 103 updates a numerical string π^{(k)} into a numerical string π^{(k+1)} in accordance with a Jacobi method as written in Eqn. 3. That is,

πᵢ^{(k+1)}=−1/qᵢᵢ×Σ_{(i#j)}(qᵢⱼ×πⱼ^{(k)}) (Eqn. 3),
(where πᵢ^{(k)} denotes an i-th numerical value in the numerical string π^{(k)} (that is, a probability that the target system is in the i-th system state), qᵢⱼ denotes a transition rate for a transition from an i-th system state to a j-th system state, and Σ_{(i≠j)} denotes that the sum is taken over all the combinations of i and j that have different values from each other).

However, when qᵢᵢ is 0, the analysis unit 103 does not update πᵢ^{(k)}. In Eqn. 3, the analysis unit 103 refers to qᵢⱼ and qᵢᵢ. When, for example, referring to qᵢⱼ, the analysis unit 103 transmits i (a state identifier, referred to as “first state identifier”) and j (a state identifier, referred to as “second state identifier”) to the calculation unit 102.

Next, the calculation unit 102 receives the first state identifier and the second state identifier. Next, the calculation unit 102 calculates a value in the case of a transition from an I-th system state to a J-th system state or Q(I, I) in accordance with Eqn. 1 (step S101). The I-th system state is indicated by the received first state identifier. The J-th system state is indicated by the second state identifier. The calculation unit 102 transmits the calculated value(s) to the analysis unit 103.

Processing details performed by the calculation unit 102 will be described later.

The analysis unit 103 receives values calculated by the calculation unit 102 and updates the numerical string π^{(k)} using each received value as qᵢⱼ or qᵢᵢ in accordance with Eqn. 3 (step S102).

When referring to qᵢᵢ, the analysis unit 103 transmits i (that is, the first state identifier) and i (that is, the second state identifier) to the calculation unit 102. In a similar manner to the above-described processing, the analysis unit 103 receives values that the calculation unit 102 calculates in accordance with Eqn. 1, and updates the numerical string π^{(k)} into a numerical string π^{(k+1)} using each received value as qᵢᵢ in accordance with Eqn. 3.

When a difference between a numerical string π^{(k)} and a numerical string π^{(k+1)} is smaller than a predetermined value ε (that is, when an inequality in Eqn. 4 holds), the analysis unit 103 finishes processing of updating the numerical string π^{(k)}.

|π^{(k+1)}−π^{(k)}|<ε (Eqn. 4),
(where “∥” denotes calculating an absolute value).

For convenience of description, it is assumed that the numerical string π^{(k+1)} satisfies Eqn. 4 in a k-th iteration. In this case, the analysis unit 103 calculates the numerical string π^{(k+1)}.

Next, the analysis unit 103 calculates availability on the basis of the calculated numerical string π^{(k+1)}. The analysis unit 103 calculates availability of the target system by calculating, for example, the total sum of π_{I}^{(k+1)} over every I-th system state that indicates that the target system is in a system operation state.

Next, with reference to FIG. 3, processing in the calculation unit 102 will be described. FIG. 3 is a flowchart illustrating a processing flow in the calculation unit 102 according to the first example embodiment.

The calculation unit 102 receives a first state identifier and a second state identifier. Next, the calculation unit 102 determines whether or not an I-th system state identified by the first state identifier is a system failure state (step S103). For example, the calculation unit 102 performs determination processing prescribed in step S103 based on whether or not the first state identifier is included in failure information 501. That is, since, as described above, a failure condition is represented by using a state identifier associated with the system failure state satisfying the condition, the calculation unit 102 compares the first state identifier with the state identifier associated with the failure state.

When an I-th system state identified by the first state identifier is a system failure state (YES in step S103), the calculation unit 102 reads a state identifier identifying a system operation state and a transition rate associated with the first state identifier from the recovery information 502. In this case, the system operation state may be represented by using a state identifier associated with the operation state.

Next, the calculation unit 102 determines whether or not the read state identifier identifying a system operation state coincides with the second state identifier (step S104). When the calculation unit 102 reads a plurality of state identifiers identifying system operation states, the calculation unit 102 performs the processing prescribed in step S104 with respect to each system operation state.

When the state identifier associated with a system operation state coincides with the second state identifier (YES in step S104), the calculation unit 102 transmits a value calculated based on the read transition rate to the analysis unit 103 (step S105).

When the state identifier associated with a system operation state does not coincide with the second state identifier (NO in step S104), the calculation unit 102 determines whether or not the first state identifier and the second state identifier coincide with each other (step S109). When the first state identifier and the second state identifier do not coincide with each other, the calculation unit 102 calculates 0 as a value and transmits the calculated 0 to the analysis unit 103 (step S106). When the first state identifier and the second state identifier coincide with each other, the calculation unit 102 calculates a value obtained by multiplying a recovery rate by minus one (that is, a value obtained by reversing the sign of a recovery rate) and transmits the calculated value to the analysis unit 103 (step S108). In this case, the recovery rate is equivalent to a transition rate for transitions from a system failure state identified by the first state identifier to a recovered state with respect to the system failure state.

Further, when the failure information 501 does not include the received first state identifier (NO in step S103), the calculation unit 102 reads a state identifier adjacent to the first state identifier in the state transition model. A state identifier adjacent to another represents a system state directly transitable from an I-th system state identified by another state identifier without via another system state in the state transition model. In this case, the calculation unit 102 calculates a transition rate for transitions from an I-th system state identified by the first state identifier to a J-th system state identified by the second state identifier on the basis of the component information, in accordance with a predetermined calculation procedure (method) (step S107).

For example, the predetermined calculation procedure is a procedure of calculating a Kronecker sum with regard to a state transition model that includes a representation of components. The predetermined calculation procedure is based on a feature that a generator matrix, that represents transitions between system states of a target system including components executing processes in a mutually independent manner, can be written as a Kronecker sum of generator matrices Qₖ which describes transitions between component states of the components. The procedure for calculating a Kronecker sum will be described later.

In the above description, it was assumed that the calculation unit 102 calculates values on the basis of a first state identifier and a second state identifier. Alternatively, the calculation unit 102 may calculate values with respect to each second state identifier on the basis of a first state identifier and a plurality of second state identifiers,

Next, an advantageous effect of the availability analysis device 101 according to the first example embodiment will be described.

The availability analysis device 101 according to first example embodiment makes it possible to analyze availability of a target system even when its scale is large. That is because it is not required to store a matrix representing transitions from first system states to second system states.

More specifically, in the example embodiment, when calculating availability, the analysis unit 103 requests values required for the calculation from the calculation unit 102 and refers to the values that the calculation unit 102 has calculated. As a result, the availability analysis device 101 is not required to store the values. That is because the calculation unit 102 is capable of calculating the values on the basis of component information, failure information, and recovery information.

On the other hand, when calculating availability, the devices disclosed in PTLs 1 and 2 store transition rates for transitions from I-th system states to J-th system states into storage units (not illustrated) as matrices. The devices calculate availability on the basis of the matrices stored in the storage units. Therefore, the devices cannot calculate availability when the storage units cannot store the matrices.

In other words, as described above, as the number of system states (the number of states, denoted by N) of a target system increases, a matrix including transition rates as elements enlarges in a proportional manner to (N×N). Therefore, when the storage units are capable of storing only (N×N) elements, the devices disclosed in PTLs 1 and 2 are capable of calculating availability for only systems of interest that have N or less system states.

On the other hand, the availability analysis device 101 according to the example embodiment, as described above, does not store a matrix into the storage unit. Therefore, even when a target system includes N or more system states, the availability analysis device 101 is capable of calculating availability for the target system. The number of system states of a target system is determined depending on the number of components included in the target system and the number of component states of the components. Therefore, since it is not required to store all elements of a matrix even when the number of components increases, the availability analysis device 101 makes it possible to analyze availability.

### Second Example Embodiment

Next, a second example embodiment of the present invention that uses the above-described first example embodiment as a base will be described.

The following description will be made with an emphasis on characteristic portions according to the example embodiment, and the same reference numbers are assigned to the same components as in the first example embodiment and an overlapping description thereof will be omitted.

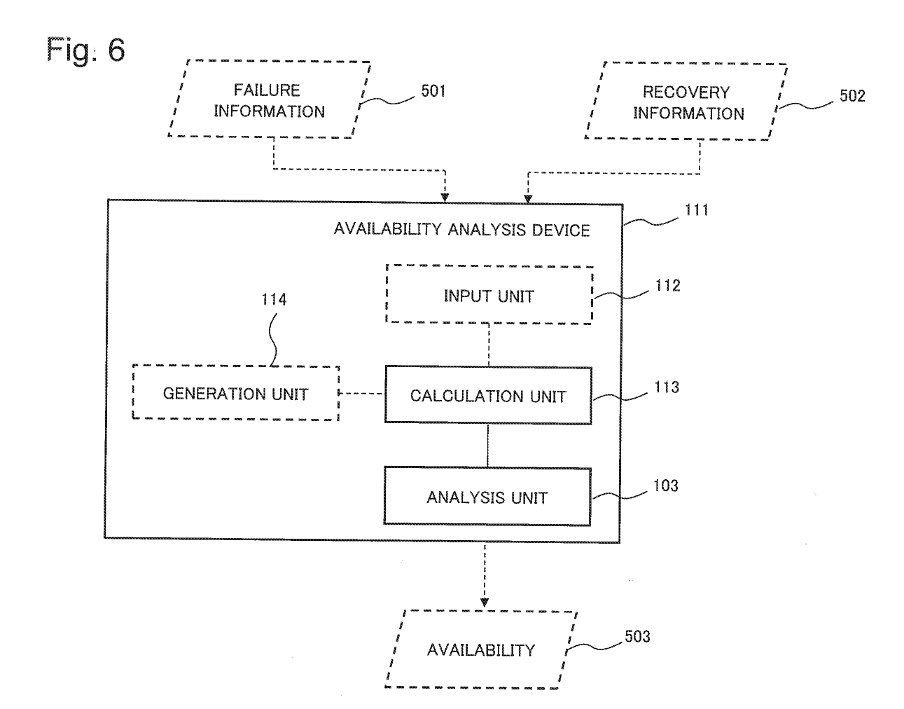

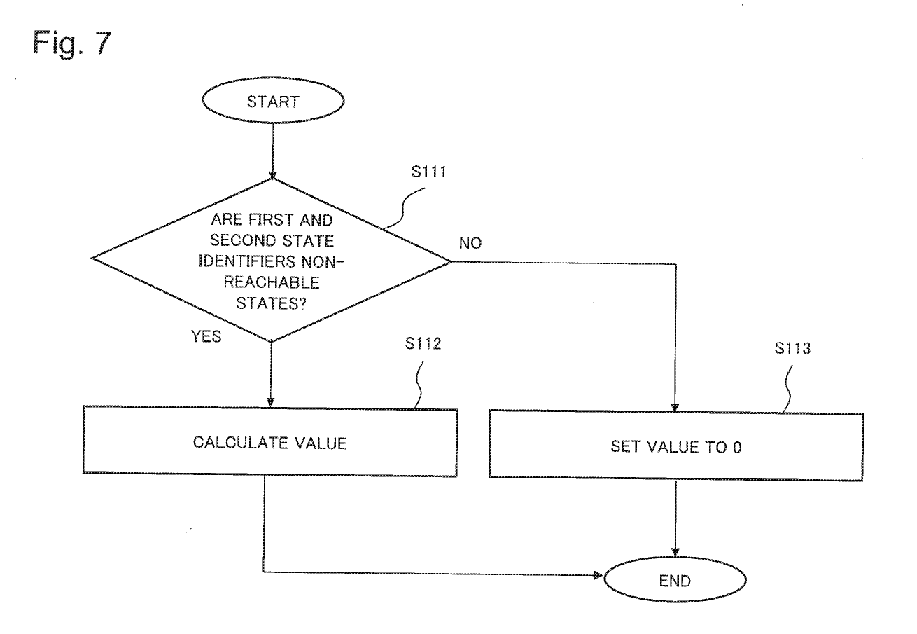

With reference to FIGS. 6 and 7, a configuration of an availability analysis device 111 according to the second example embodiment and processing performed in the availability analysis device 111 will be described. FIG. 6 is a block diagram illustrating a configuration of the availability analysis device 111 according to the second example embodiment of the present invention. FIG. 7 is a flowchart illustrating a processing flow performed in the availability analysis device 111 according to the second example embodiment.

The availability analysis device 111 according to the second example embodiment includes a calculation unit 113 and an analysis unit 103. The availability analysis device 111 may further include an input unit 112 and a generation unit 114.

The calculation unit 113 determines whether or not non-reachability information includes either of received state identifiers (step S111). The non-reachability information is made up of state identifiers identifying states that represent one or more components being further brought to failure states from a system failure state (hereinafter, referred to as “non-reachable state” because the reachability of such a state is not required to be taken into consideration from the viewpoint of the purpose of availability analysis). Alternatively, the calculation unit 113 may determine whether or not reachability information includes either of received state identifiers. The reachability information is made up of state identifiers identifying system states that are different from non-reachable states (hereinafter, referred to as “reachable state”).

As described above, a non-reachable state is a failure state which is not directly transitable from a system operation state. A reachable state is equivalent to a system state different from the non-reachable states.

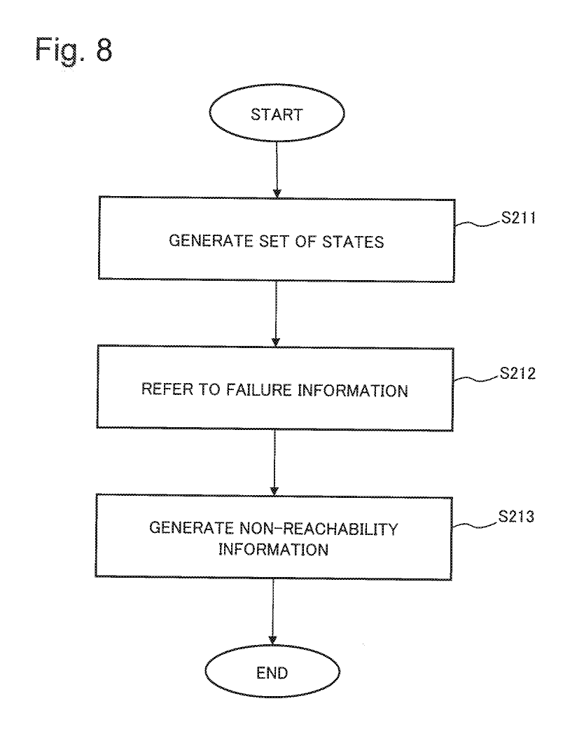

First, with reference to FIG. 8, a processing flow and the like of generating the reachability information or the non-reachability information will be described. FIG. 8 is a flowchart illustrating an example of a processing flow of generating the reachability information and the like.

It is assumed that the availability analysis device 111 according to the example embodiment receives the reachability information or the non-reachability information. However, as will be described later, the availability analysis device 111 may include the generation unit 114 generating the reachability information or the non-reachability information in accordance with processing illustrated in FIG. 8.

The generation unit 114 generates a set 92 of system states of a target system on the basis of component states of respective components included in the target system (step S211). The generation unit 114 generates system states of the target system by combining respective component states of the respective components with one another.

For example, it is assumed that the target system includes a component A and a component B. It is assumed that the states of the component A are a component state Uₐ and a component state Fₐ. It is assumed that the states of the component B are a component state U_{b} and a component state F_{b}. It is also assumed that the component state Fₐ denotes a component failure state of the component A. It is assumed that the component state F_{b} denotes a component failure state of the component B. It is assumed that the component state Uₐ denotes a component operation state of the component A. It is assumed that the component state U_{b} denotes a component operation state of the component B.

In this case, the generation unit 114 generates a set Ω of system states of the target system as shown in Eqn. 5 by combining component states of the respective components (step S211).

Ω={(Uₐ,U_{b}),(Uₐ,F_{b}),(Fₐ,U_{b}),(Fₐ,F_{b})} (Eqn. 5).

In Eqn. 5, (Uₐ, U_{b}), (Uₐ, F_{b}), (Fₐ, U_{b}), or (Fₐ, F_{b}) is an example of a system state.

For example, when either the component A or the component B is in a component failure state, the target system is assumed to be in a system failure state. In this case, within the set 92, the system failure states of the target system consist of a system failure state (Uₐ, F_{b}), a system failure state (Fₐ, U_{b}), and a system failure state (Fₐ, F_{b}).

For example, when the component B is in a component failure state, the target system is in the system failure state (Uₐ, F_{b}). The target system loses its function included intrinsically in the target system by being brought to (falling into) a system failure state. In response to this functional loss, recovery processing is performed for the target system in accordance with a recovery procedure. As a result of the recovery processing, it is not occurred that the component A is further brought to a component failure state in the target system. Therefore, there is no possibility that the target system transitions from the system state (Uₐ, U_{b}) to the system state (Fₐ, F_{b}) without going through one or more system failure states.

In the case of the above-described example, non-reachability information is made up of a state identifier identifying the system state (Fₐ, F_{b}). That is, in this case, the non-reachability information includes a state identifier identifying a system failure state that is transitable via one or more system failure states. Reachability information is made up of state identifiers identifying the system state (Uₐ, U_{b}), the system state (Uₐ, F_{b}), and the system state (Fₐ, U_{b}).

For example, it is assumed that a system failure state is defined as states where three or more types of components in a target system are in component failure states when the target system has five types of components. In this case, non-reachable states in the system states are states where four or more types of components in the target system are in component failure states.

With reference to FIG. 8, processing in step S212 and the subsequent steps will be described. For example, the generation unit 114 determines whether or not the respective elements satisfy failure conditions included in failure information 501 for the target system by applying the failure conditions to the elements included in the set Ω (step S212). Next, the generation unit 114 extracts an element(s) (referred to as “second element”), that includes the same component states included in a system failure state except one component state with respect to an element representing a system failure state (referred to as “first element”), out of the set Ω.

Next, the generation unit 114 checks whether or not the second element(s) satisfy(ies) the failure condition. When all the extracted second elements satisfy the failure condition, the generation unit 114 adds the first element to the non-reachability information (step S213). When there is an element that does not satisfy the failure condition among the extracted second elements, the generation unit 114 adds the first element to the reachability information.

Furthermore, the generation unit 114 adds a state identifier(s) included in the operation information to the reachability information.

The input unit 112 receives reachability information on the target system from the outside or the generation unit 114 and stores the reachability information in a storage unit (not illustrated).

With reference to FIG. 7, processing in step S111 and the subsequent steps will be described. When a system state identified by either of the received state identifiers is included in the non-reachability information (NO in step S111), the calculation unit 113 sets a value at 0 (step S113). When the non-reachability information includes neither received state identifier (YES in step S111), the calculation unit 113 calculates a value by the processing prescribed in steps S103 to S107 in FIG. 3 (step S112).

Next, an advantageous effect of the availability analysis device 111 according to the second example embodiment will be described.

The availability analysis device 111 according to the example embodiment further reduces the calculation time in addition to the advantageous effect included in the availability analysis device 101 according to the first example embodiment.

The reason for the advantageous effect is the following reasons 1 and 2:

(Reason 1) the configuration of the availability analysis device 111 according to the second example embodiment contains the configuration of the availability analysis device 101 according to the first example embodiment; and

(Reason 2) processing related to non-reachable states is eliminated.

As described above, the calculation unit 113 first determines whether or not a system state identified by a first state identifier or a second state identifier is a non-reachable state, and, when either is a non-reachable state, sets a value at 0. When system states identified by the first state identifier and the second state identifier are not non-reachable states, the calculation unit 113 performs processing prescribed in step S112. Therefore, compared with the availability analysis device 101 according to the first example embodiment, the amount of processing prescribed in step S112 is reduced. As a result, the availability analysis device 111 according to the example embodiment reduces the calculation time further.

### Third Example Embodiment

Next, a third example embodiment of the present invention, which is configured using the above-described second example embodiment as a base, will be described.

The following description will be made with an emphasis on characteristic portions according to the example embodiment, and the same reference numbers are assigned to the same components as in the second example embodiment and an overlapping description thereof will be omitted.

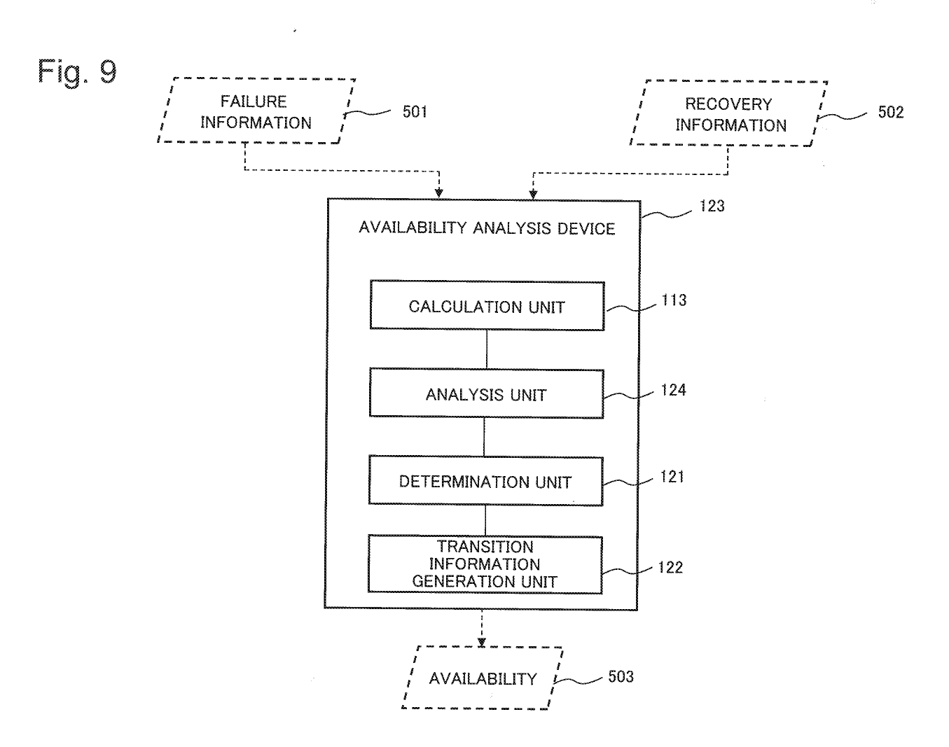

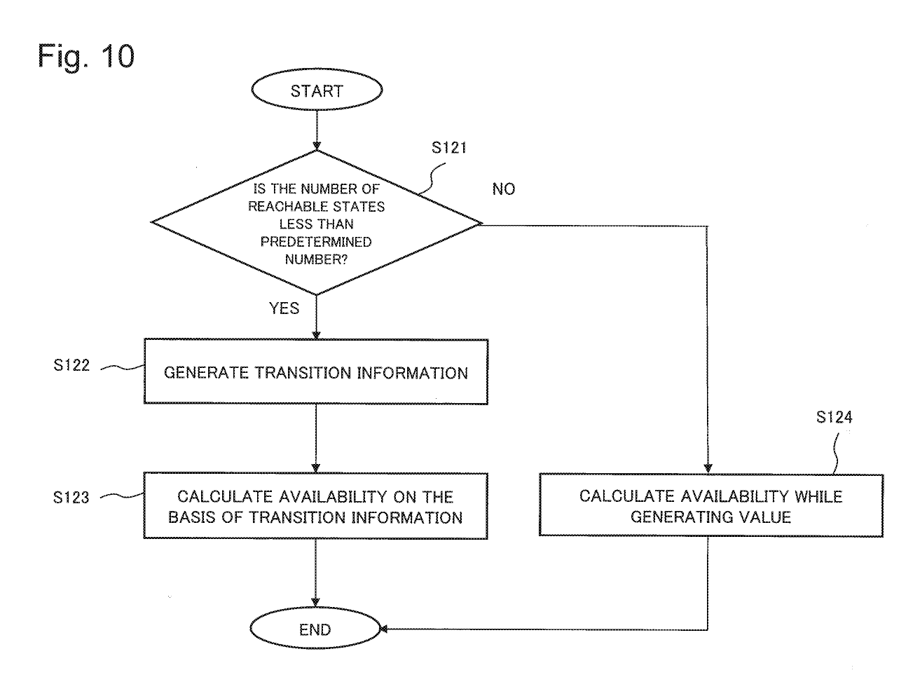

With reference to FIGS. 9 and 10, a configuration of an availability analysis device 123 according to the third example embodiment and processing executed in the availability analysis device 123 performs will be described. FIG. 9 is a block diagram illustrating a configuration of the availability analysis device 123 according to the third example embodiment of the present invention. FIG. 10 is a flowchart illustrating a processing flow in the availability analysis device 123 according to the third example embodiment.

The availability analysis device 123 according to the third example embodiment includes a calculation unit 113, an analysis unit 124, a determination unit 121, and a transition information generation unit 122.

The determination unit 121 determines whether or not the number of state identifiers identifying reachable states included in reachability information (hereinafter, referred to as “the number of reachable states”) is less than a predetermined number (step S121).

When the determination unit 121 determines that the calculated number of reachable states is less than a predetermined number (YES in step S121), the transition information generation unit 122 generates transition information that represents situations of transitions between reachable states on the basis of values calculated by the calculation unit 113 (step S122). For example, the transition information generation unit 122 transmits state identifiers identifying reachable states to the calculation unit 113. The calculation unit 113 receives the state identifiers, calculates values concerning the received state identifiers, and transmits the calculated values to the transition information generation unit 122. The transition information generation unit 122 receives the values and stores the received values into the transition information. The transition information may be represented by using the above-described infinitesimal generator matrix. In the case of, for example, the transition information is generated by storing values calculated by the calculation unit 113 into a matrix Q(I, J) when a state of the target system transits from an I-th system state (reachable state) to a J-th system state (reachable state). Next, the analysis unit 124 calculates availability on the basis of the transition information (step S123).

The transition information generated by the transition information generation unit 122 is equivalent to an infinitesimal generator matrix with respect to reachable states of the target system.

On the other hand, when the determination unit 121 determines that the calculated number of reachable states is greater than or equal to the predetermined number (NO in step S121), the analysis unit 124 calculates availability by processing prescribed in steps S101 and S102 in FIG. 2 (step S124).

Next, an advantageous effect of the availability analysis device 123 according to the third example embodiment will be described.

The availability analysis device 123 according to the example embodiment further makes it possible to calculate availability with high speed in addition to the advantageous effect obtained by the availability analysis device 111 according to the second example embodiment.

The reason for the advantageous effect is the following reasons 1 and 2:

(Reason 1) the configuration of the availability analysis device 123 according to the third example embodiment contains the configuration of the availability analysis device 111 according to the second example embodiment; and

(Reason 2) generating the transition information makes it unnecessary to calculate a transition rate for a transition from an I-th system state to a J-th system state and the like repeatedly.

When the number of reachable states is less than the predetermined number, the availability analysis device 123 generates the transition information. Through this processing, the availability analysis device 123 generates a situation where a storage area for storing the transition information is restricted and a situation where processing of calculating a transition rate and the like repeatedly is avoided.

### Fourth Example Embodiment

Next, a fourth example embodiment of the present invention, which is configured using the above-described third example embodiment as a base, will be described.

The following description will be made with an emphasis on characteristic portions according to the example embodiment, and the same reference numbers are assigned to the same components as in the third example embodiment and an overlapping description thereof will be omitted.

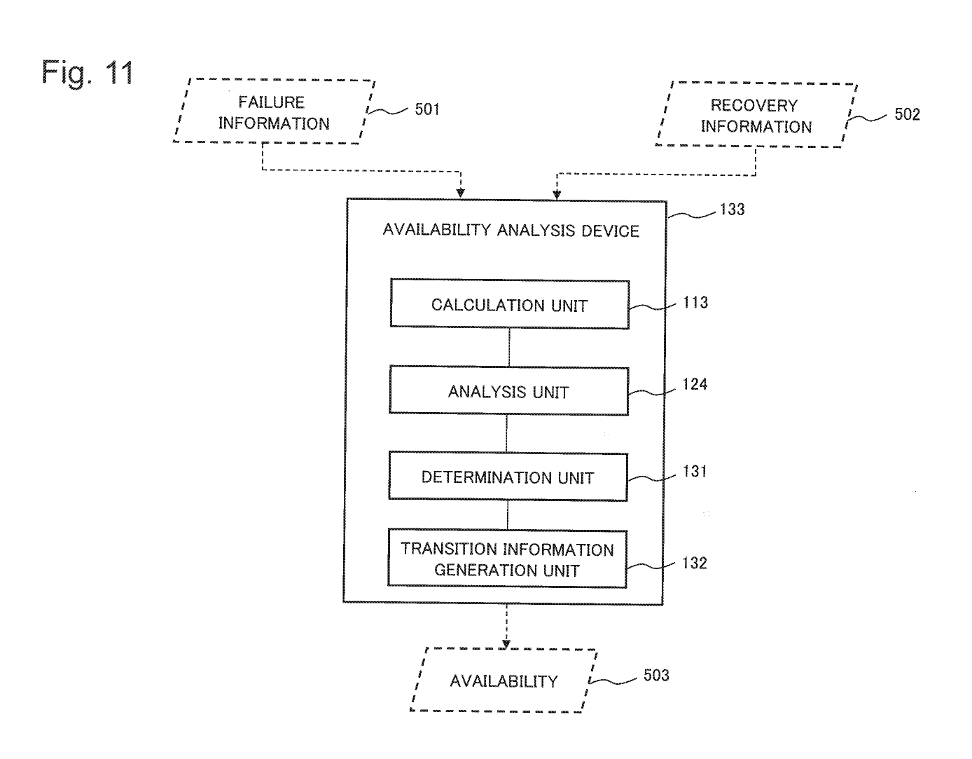

With reference to FIG. 11, a configuration of an availability analysis device 133 according to the fourth example embodiment and processing executed by the availability analysis device 133 will be described. FIG. 11 is a block diagram illustrating a configuration of the availability analysis device 133 according to the fourth example embodiment of the present invention.

The availability analysis device 133 according to the fourth example embodiment includes a calculation unit 113, an analysis unit 124, a determination unit 131, and a transition information generation unit 132.

The determination unit 131 determines whether or not the number of reachable states included in reachability information is less than a predetermined number.

When the number of reachable states is less than the predetermined number, the transition information generation unit 132 generates transition information representing situations of transitions between reachable states. However, the transition information generation unit 132 processes system failure states of a target system collectively as a single system failure state. For example, when, as described in the above-described example, the target system includes a component A and a component B, the transition information generation unit 132 processes a system state (Uₐ, F_{b}) and a system state (Fₐ, U_{b}) collectively as a single system failure state. In this case, the system state (Uₐ, F_{b}) and the system state (Fₐ, U_{b}) are system failure states of the target system.

In the case of this example, the transition information generation unit 132, for example, allocates a system state denoted by Fₛ to the two system states (Uₐ, F_{b}) and (Fₐ, U_{b}). The transition information generation unit 132 further allocates another system state denoted by Uₛ to a system operation state (Uₐ, U_{b}) of the target system. In this case, since a system state (Fₐ, F_{b}) is a non-reachable state, the transition information generation unit 132 does not allocate any system state to (Fₐ, F_{b}). That is, the transition information generation unit 132 processes two system states Uₛ and Fₛ as the system states of the target system.

The transition information generation unit 132, for example, applies an operation that will be described later to two values including a value that the calculation unit 113 calculates with respect to a transition from the system state (Uₐ, F_{b}) to another state and a value that the calculation unit 113 calculates with respect to a transition concerning the system state (Fₐ, U_{b}). The transition information generation unit 132 performs a process where the two system states (Uₐ, F_{b}) and (Fₐ, U_{b}) are collectively processed as one system state Fₛ through this operation. The transition information generation unit 132 generates a matrix Q on the basis of results of calculations in a similar manner to the transition information generation unit 122 according to the third example embodiment.

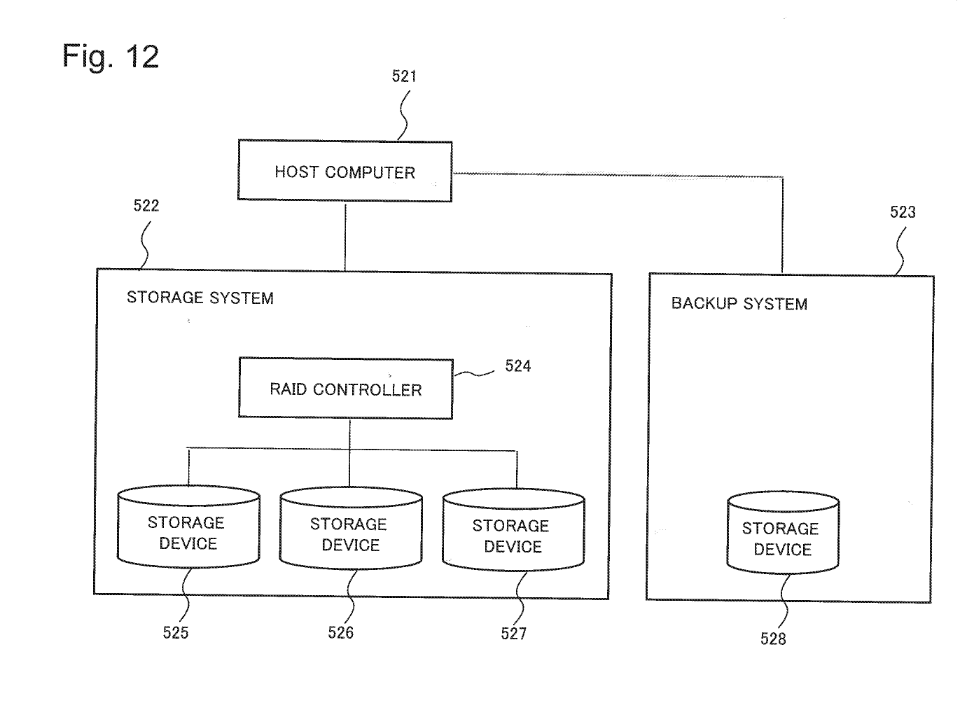

Next, by using a specific example relating to a storage system, processing in the availability analysis device 133 according to the example embodiment will be described. In this example, the availability analysis device 133, on the basis of a continuous time Markov chain, calculates availability of a storage system 522 employing RAID (Redundant Array of Independent Disks) level 5 as illustrated in FIG. 12. FIG. 12 is a block diagram illustrating an example of a configuration of an information system including the storage system 522 employing RAID.

In this example, the availability analysis device 133 calculates availability of the storage system 522 including a plurality of storage devices. Each storage device is a magnetic disk, a non-volatile semiconductor memory, or the like. A mode that each storage device has is not limited to the above-described examples.

RAID technology is a technology that improves the reliability, performance, and the like of a storage system. The availability of a storage system employing a RAID technology depends on the reliability of storage devices configured into RAID, efficiency in processing of recovering data when a storage device is in a failure state, efficiency in recovery processing when data are lost, and the like.

The availability of a storage system further depends on a RAID level, which prescribes a mode in which data are stored.

For example, when a RAID level is 5, a storage system calculates parity for data in storing the data into storage devices. The storage system stores the data and the calculated parity into the storage devices. In such a storage system, when a storage device out of the storage devices is brought to a component failure state, the storage device that has been brought to the component failure state is replaced with a new storage device. The storage system restores data that have been stored in the storage device at which the failure occurred on the basis of the calculated parity and data stored in the other storage devices. The storage system stores the restored data into the new storage device.

However, when two storage devices out of the storage devices have failures, the storage system employing RAID level 5 is incapable of restoring data stored in the storage devices having failures on the basis of parity. In this case, the storage system is reconstructed by using backup data and the like. Users are unable to use the storage system while the storage system is being reconstructed.

With reference to FIG. 12, the storage system 522 includes a RAID (assumed to be at RAID level 5) controller 524, and storage devices 525, 526, and 527. A backup system 523 includes a storage device 528. A host computer 521 is communicable with the storage system 522 and the backup system 523.

The backup system 523 stores data that are stored in the storage devices, which are organized in a RAID configuration by the RAID controller 524, into the storage device 528. Users of the storage system 522 perform reading and writing of data stored in the storage devices by way of the host computer 521. Further, the host computer 521 regularly backs up the data in the backup system 523 in preparation for, for example, losing data stored in the storage system 522. The host computer 521 analyzes a probability (availability) for capability of access to data stored in the storage system 522. Here, the host computer 521 is assumed to include an availability analysis device 133.

Users input operation information on the storage system 522, information on respective components, and the like to an input unit 104 (FIG. 1).

The input unit 104 generates a state transition model on the basis of components included in the storage system 522 (for example, the storage devices 525 to 527).

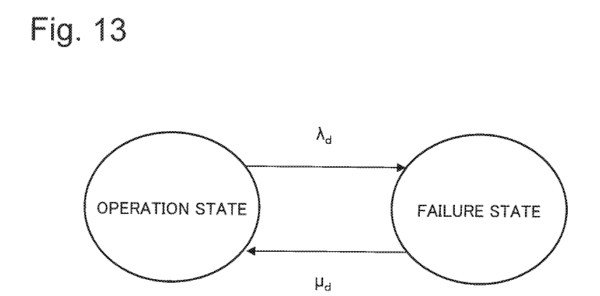

For convenience of description, it is assumed that, as exemplified in FIG. 5, the RAID controller 524 is represented by using a continuous time Markov chain that includes two states, namely a component operation state and a component failure state. In FIG. 5, a failure rate and a recovery rate of the RAID controller 524 are denoted by λ_{c} and μ_{c}, respectively. Similarly, each of the storage devices 525, 526, and 527 is assumed to be represented by using a continuous time Markov chain including two states, namely a component operation state and a component failure state, as exemplified in FIG. 13. FIG. 13 is a diagram conceptually illustrating an example of a continuous time Markov chain related to a storage device. In FIG. 13, a failure rate and a recovery rate of a storage device are denoted by λ_{d} and μ_{d}, respectively.

For convenience of description, the component states of the RAID controller 524 and the storage devices 525, 526, and 527 are denoted by x₁, x₂, x₃, and x₄, respectively. Each xᵢ is defined as xᵢ(i=1, 2, 3, 4)={0, 1} (where “0” and “1” denote a component operation state and a component failure state, respectively). In this case, a set Ω of the system states of the storage system 522 can be represented by using system states (x₁, x₂, x₃, x₄) that is a combination of component states of the respective components.

The storage system 522 is defined to be in a system operation state when two or more storage devices out of the storage devices 525, 526, and 527 and the RAID controller 524 are in operation. Therefore, the input unit 104 receives, for example, an operation condition A shown in Eqn. 6 as operation information on the storage system 522.

Operation condition A: x₁ [symbol] (x₂ [symbol] x₃ [symbol] x₂ [symbol] x₄ [symbol] x₃ [symbol] x₄) (Eqn. 6),
(where [symbol] and [symbol] denote a logical product and a logical sum, respectively).

Operation information, however, does not always have to be a logical description as shown in Eqn. 6.

In this case, the operation condition A prescribes an operation condition for the storage system 522 and takes a value of 0 when the storage system 522 is in an operation state.

On the other hand, the storage system 522 is defined to be in a system failure state when the RAID controller 524 is in a component failure state (Eqn. 7) or two storage devices out of the three storage devices are in component failure states (Eqn. 8). In this case, the input unit 104 receives Eqns. 7 and 8 as failure information 501 on the storage system 522.

Failure condition FC: x₁ (Eqn. 7), and

failure condition FS: x₂ [symbol] x₃ [symbol] x₂ [symbol] x₄ [symbol] x₃ [symbol] x₄ (Eqn. 8).

When the storage system 522 is in a system failure state, either the failure condition FC or the failure condition FS takes a value of 1.

Hereinafter, for convenience of description, a recovery rate at which the RAID controller 524 recovers from a component failure state to a component operation state is denoted by a_{C}. A recovery rate at which, when two storage devices out of the three storage devices are in failure states, the storage system 522 is reconstructed by restoring data from the backup system 523 is denoted by a_{S}. In addition, a system state of the storage system 522 after recovery is denoted by (x₁, x₂, x₃, x₄)=(0, 0, 0, 0).

The input unit 104 receives Eqns. 9 and 10 as recovery information 502 on the storage system 522. The input unit 104 may generate the recovery information 502.

(Failure condition FC,(0,0,0,0),a_{C}) (Eqn. 9),

and

(failure condition FS,(0,0,0,0),a_{S}) (Eqn. 10).

Next, the analysis unit 124 generates a numerical string π⁽¹⁾. The storage system 522 can be in 16 (=2⁴) different system states. Thus, the numerical string π⁽¹⁾ includes 16 numerical values. A numerical analysis method in the analysis unit 124 is, for example, a Jacobi method described in the first example embodiment. The analysis unit 124 updates a numerical string π^{(k)} to a numerical string π^{(k+1)}, and, when the difference between the numerical string π^{(k)} and the numerical string π^{(k+1)} has become sufficiently small, finishes processing of updating the numerical string π^{(k)}.

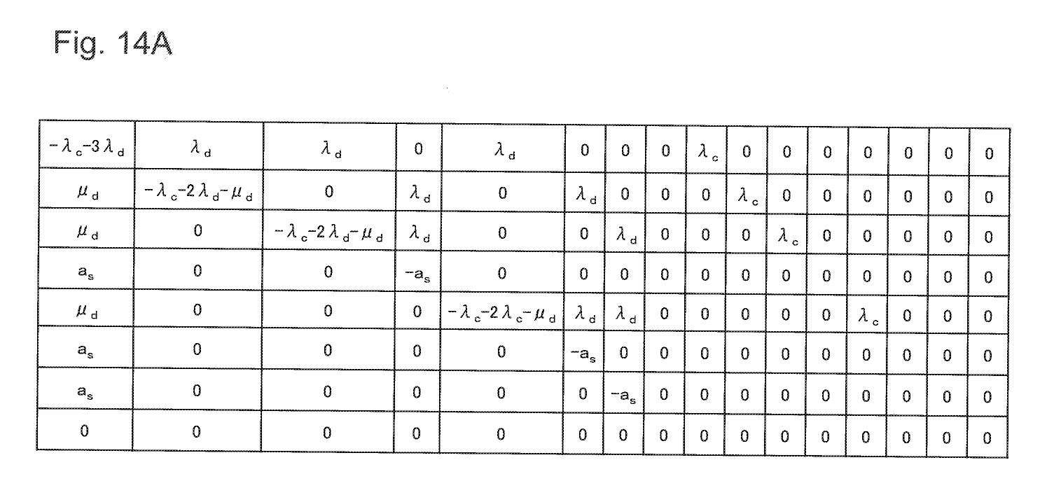

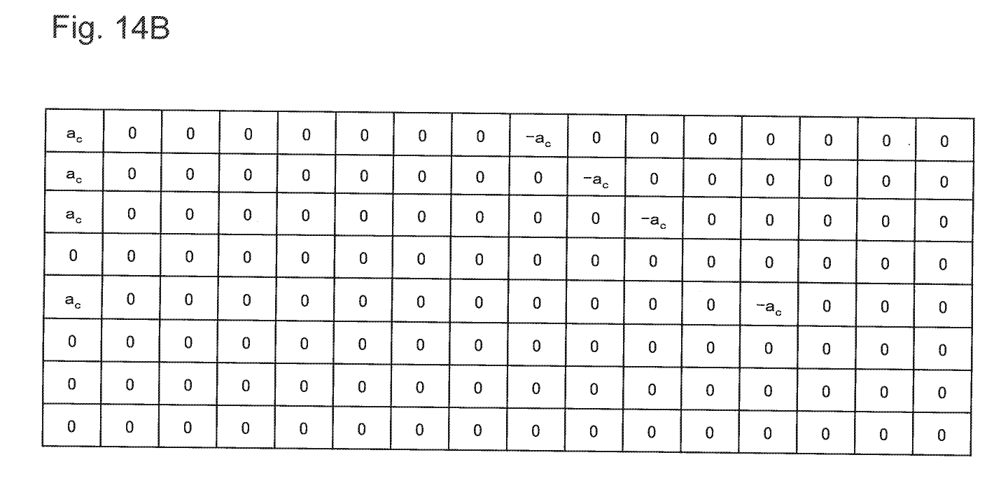

In the processing of updating the numerical string π^{(k)}, the analysis unit 124 refers to only values of some qᵢⱼ (for example, qᵢⱼ for reachable states) that have been calculated as results of the processing described in the respective example embodiments of the present invention in a matrix Q exemplified in FIGS. 14A and 14B. FIGS. 14A and 14B are diagrams illustrating an example of a generally used matrix Q, which is separated and illustrated in two drawings due to constraints on illustration. An element qᵢⱼ at an i-th row and j-th column in the matrix Q represents a transition rate for a transition from an i-th system state to a j-th system state. An element qᵢᵢ has a value obtained by multiplying the total sum of transition rates each for a transition from such an i-th system state to another system state by “−1”. When such an i-th system state is a reachable state, qᵢⱼ is calculated by a calculation unit (for example, the calculation unit 102 or the calculation unit 113) through a series of processing as illustrated in the flowchart in FIG. 3. Step S107 in FIG. 3 is processing in which the calculation unit 113 performs calculation based on a Kronecker sum written in Eqn. 13, which will be described later. On the other hand, when such an i-th system state is a non-reachable state, qᵢⱼ and qᵢᵢ are 0.

The analysis unit 124 may, for example, transmit values of i and j to the calculation unit 113. In this case, the calculation unit 113 calculates a value of qᵢⱼ and transmits the calculated qᵢⱼ to the analysis unit 124. The analysis unit 124 receives the calculated qᵢⱼ and updates the numerical string π^{(k)} on the basis of the received qᵢⱼ.

An index I in the matrix Q can be obtained by, for example, applying a function exemplified in Eqn. 11 to a system state (x₁, x₂, x₃, x₄) of the storage system 522. The function may be a function that associates a system state of the storage system 522 with an index I in the matrix Q on a one-on-one basis.

I=8×x₁+4×x₂+2×x₃+x₄+1 (Eqn. 11),
(where “+” denotes addition).

For example, applying Eqn. 11 to a system state (0, 1, 0, 0) yields a value “5”. In this case, the system state (0, 1, 0, 0) relates to the fifth system state, that is, the fifth row in the matrix Q and the fifth column in the matrix Q. For example, q₅ⱼ (where j is an integer) denotes a transition rate for a transition from the fifth system state to a j-th system state. For example, qᵢ₅ (where i is an integer) denotes a transition rate for a transition from an i-th system state to the fifth system state.

FIGS. 14A and 14B include rows all the elements of which have a value of 0 or columns all the elements of which have a value of 0. Such rows and columns indicate that system states corresponding to the indices thereof are non-reachable states.

The determination unit 131 may calculate the number of reachable states by calculating non-reachable states using the failure condition FS, the component states x₁, x₂, x₃, and x₄, and Eqn. 12.

U=x₂ [symbol] x₃ [symbol] x₄ [symbol] x₁ [symbol] FS (Eqn. 12).

Eqn. 12 yields a value of 1 when a system state (x₁, x₂, x₃, x₄) that the storage system 522 takes is a non-reachable state. In this case, a non-reachable state is either a state in which all the three storage devices are in component failure states (that is, x₂=x₃=x₄=1) or a state in which, when the RAID controller 524 is in a component failure state, two or more storage devices are in component failure states.

For example, a system state (1, 1, 1, 0) indicates a state in which the RAID controller 524 and the storage devices 525 and 526 are in component failure states. When the RAID controller 524 is brought to a component failure state or, out of the three storage devices, two storage devices are brought to component failure states, the storage system 522 is brought to the system failure state, which causes the storage system 522 to stop the functions thereof. Therefore, the storage system 522 does not transition to the system state (1, 1, 1, 0). In this case, the system state (1, 1, 1, 0) is a non-reachable state.

When a system state identified by a first state identifier or a system state identified by a second state identifier is a non-reachable state, the calculation unit 113 calculates a value of 0. Such a system state corresponds to a row all the elements of which have a value of 0 or a column all the elements of which have a value of 0 in FIGS. 14A and 14B. The transition information generation unit 132 generates the matrix Q in such a way that the matrix Q does not contain a row(s) all the elements of which have a value of 0 or a column(s) all the elements of which have a value of 0.

When a system state identified by a first state identifier and a system state identified by a second state identifier are non-reachable states, the calculation unit 113 determines whether or not the system state identified by the first state identifier is a system failure state. For example, in this case, the calculation unit 113 determines whether or not the storage system 522 is in a system failure state in accordance with Eqns. 7 and 8.

When a state identified by a first state identifier is a system failure state, the calculation unit 113 calculates a value on the basis of the recovery information 502. For example, when a system state identified by a first state identifier is determined to be a system failure state in accordance with Eqn. 7 (that is, the failure condition FC), the calculation unit 113 reads a transition rate a_{C} associated with the failure condition FC from the recovery information 502. The calculation unit 113 calculates “−a_{C}” when a first state identifier and a second state identifier coincide with each other, and sets a value to a_{C} when a first state identifier and a second state identifier do not coincide with each other. This processing is based on the definition of the matrix Q.

When a system state identified by a first state identifier is not a system failure state, the calculation unit 113, for example, calculates values of elements in the matrix Q in accordance with a procedure for calculating a Kronecker sum that is disclosed in NPL 1 and the like. The procedure for calculating a Kronecker sum that is disclosed in NPL 1 and the like is based on a feature that a generator matrix representing state transitions with respect to a target system that includes components operating in a mutually independent manner is represented by the Kronecker sum of generator matrices each representing state transitions with respect to a component.

For example, the calculation unit 113 calculates values of qᵢⱼ based on the definition of a Kronecker sum shown as in Eqn. 13 and matrix elements for the components.

$${Q}_{A} = [ \begin{matrix}{q}_{A 00} & {q}_{A 01} \\ {q}_{A 10} & {q}_{A 11}\end{matrix} ] , \\ {Q}_{B} = [ \begin{matrix}{q}_{B 00} & {q}_{B 01} \\ {q}_{B 10} & {q}_{B 11}\end{matrix} ] , \\ {Q}_{A} * {Q}_{B} = [ \begin{matrix}{q}_{A 00} + {q}_{B 00} & {q}_{B 01} & {q}_{A 01} & 0 \\ {q}_{B 10} & {q}_{A 00} + {q}_{B 11} & 0 & {q}_{A 01} \\ {q}_{A 10} & 0 & {q}_{A 11} + {q}_{B 00} & {q}_{B 01} \\ 0 & {q}_{A 10} & {q}_{B 10} & {q}_{A 11} + {q}_{B 11}\end{matrix} ] \qquad ( Eqn . 13 )$$

(where “*” denotes a Kronecker sum).

The calculation unit 113 is capable of calculating values of the matrix Q in accordance with the above-described processing.

The analysis unit 124 calculates availability of the storage system 522 by calculating a sum of probabilities over system operation states on the basis of the calculated numerical string π^{(k+1)} (that is, probabilities at a steady state).

When the number of components in a target system increases, the number of system states increases exponentially with respect to the number of components. The same feature also applies to a case of calculating availability on the basis of more specific component states of the respective components. Thus, it becomes difficult for a device disclosed in PTL 1 or 2 to analyze the availability of a target system when the number of components in the target system increases.

Next, using the above-described example, processing in the transition information generation unit 132 will be described.

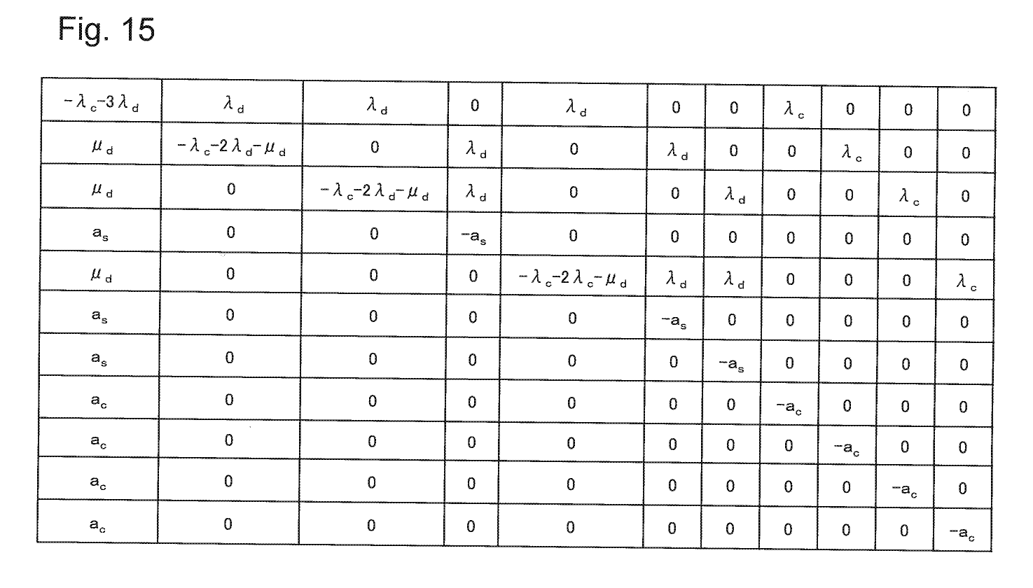

With reference to the matrix Q exemplified in FIGS. 14A and 14B, reachable states are 11 types of system states out of 16 types of system states corresponding to 16 rows that compose the matrix Q. When the number of reachable states is less than a predetermined number, the transition information generation unit 132 generates a matrix R for the reachable states as illustrated in FIG. 15. FIG. 15 is a diagram conceptually illustrating an example of a matrix for reachable states. The matrix R exemplified in FIG. 15 is a matrix made up of rows corresponding to the reachable states and columns corresponding to the reachable states out of the elements of the matrix Q exemplified in FIGS. 14A and 14B.

In this case, the size of the matrix Q is the square of the number of reachable states and at most the square of a predetermined number. If the square of a predetermined number is smaller than a capacity that the storage devices have, the storage devices are able to contain the matrix Q. When the storage devices are able to contain the matrix Q, the transition information generation unit 132 generates the matrix Q and stores the generated matrix Q into the storage devices.

In this case, the analysis unit 124 may, for example, update the numerical string π^{(k)} referring to the matrix Q in the storage devices. Thus, the calculation unit 113 no longer has to repeatedly calculate elements included in the matrix Q in the processing of the analysis unit 124 updating the numerical string π^{(k)}.

Next, referring to the above-described example, processing performed by the availability analysis device 133 according to the example embodiment and arithmetic processing of generating a matrix Q from the matrix R on the basis of respective values that the calculation unit 113 calculates with respect to a plurality of states will be described.

The transition information generation unit 132, for example, processes a plurality of system failure states as a single system failure state. When, even if system failure states are distinct from each other in the recovery information 502, the system failure states are commonly associated with a system operation state and are commonly associated with a transition rate, the transition information generation unit 132 processes the system failure states collectively as a single system failure state. This processing is performed to rows corresponding to system failure states and columns corresponding to the system failure states in the matrix R.

First, processing applied to rows corresponding to system failure states among the processing of calculating the matrix Q on the basis of the matrix R will be described. Referring to information as shown in Eqn. 10 in the recovery information 502 as an example, processing of calculating transition rates will be described. System failure states that is directly transitable, at transition rate as, to a system state (0, 0, 0, 0) that indicates a state after recovering from a system failure are calculated as system failure states satisfying the failure condition FS (specifically, Eqn. 8) included in Eqn. 10. That is, the system failure states include a system failure state (0, 1, 1, 0), a system failure state (0, 0, 1, 1), and a system failure state (0, 1, 0, 1). The transition information generation unit 132 processes the three system failure states collectively as a single system failure state.

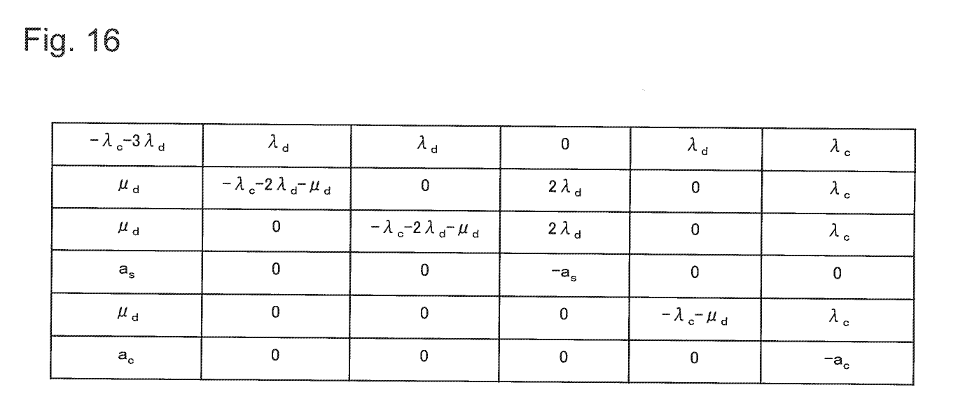

That is, the transition information generation unit 132 is able to generate the matrix Q exemplified in FIG. 16 by processing such three system failure states collectively as the single system failure state. That is, the transition information generation unit 132 calculates the sum of the values of the elements composing the system failure states that are processed collectively as a single system failure state (in this case, the above-described three types of system failure states) in generating such a matrix Q.

With reference to FIGS. 15 and 16, the above-described processing that the transition information generation unit 132 performs will be described below more specifically. FIG. 16 is a diagram conceptually illustrating an example of a matrix that is generated when system failure states subjected to the processing are processed as a single system failure state. For convenience of description, it is assumed that the matrix before change, exemplified in FIG. 15, and the matrix after change, exemplified in FIG. 16, are referred to as “matrix R” and “matrix Q”, respectively.

In this example, for convenience of description, it is assumed that, the transition information generation unit 132 calculates indices of the matrix R corresponding to each system failure state referring to Eqn. 11, on the basis of the three types of system failure states, in accordance with the afore-described procedure for generating the matrix R from system states. For example, in the case of the matrix R exemplified in FIG. 15, the transition information generation unit 132 calculates a value “4” which represents the index of the state for a system failure state (0, 0, 1, 1) in accordance with Eqn. 11. For example, in the case of the matrix R exemplified in FIG. 15, the transition information generation unit 132 calculates a value “6”, which represents the index of the state for a system failure state (0, 1, 0, 1) in accordance with Eqn. 11. For example, in the case of the matrix R exemplified in FIG. 15, the transition information generation unit 132 calculates a value “7” which represents the index of the state for a system failure state (0, 1, 1, 0) in accordance with Eqn. 11. That is, in the case of the matrix R exemplified in FIG. 15, the system failure state (0, 0, 1, 1) indicates a system failure state represented by the fourth row. In the case of the matrix R exemplified in FIG. 15, the system failure state (0, 1, 0, 1) indicates a system failure state represented by the sixth row. In the case of the matrix R exemplified in FIG. 15, the system failure state (0, 1, 1, 0) indicates a system failure state represented by the seventh row. That is, such indices indicate row numbers or column numbers of the matrix R. In the case of the matrix Q exemplified in FIG. 16, the system failure states that are processed collectively as a single system failure state are represented by a system failure state represented by the fourth row.

For convenience of description, it is assumed that a system operation state represented by the first row of the matrix Q exemplified in FIG. 16 indicates a system operation state represented by the first row of the matrix R exemplified in FIG. 15. It is assumed that a system operation state represented by the second row of the matrix Q exemplified in FIG. 16 indicates a system operation state represented by the second row of the matrix R exemplified in FIG. 15. It is assumed that a system operation state represented by the third row of the matrix Q exemplified in FIG. 16 indicates a system operation state represented by the third row of the matrix R exemplified in FIG. 15. It is assumed that a system operation state represented by the fifth row of the matrix Q exemplified in FIG. 16 indicates a system operation state represented by the fifth row of the matrix R exemplified in FIG. 15.

In the above-described case, when, with respect to one or more types of system failure states that are processed collectively as a single system failure state, there exist a plurality of types of system failure states that are combined into the single system failure state, a value of an element corresponding to the single system failure state in the matrix Q exemplified in FIG. 16 can be calculated as the sum of values of elements, in the matrix R exemplified in FIG. 15, each of which is calculated with respect to one of the plurality of types of system failure states. More specifically, the transition information generation unit 132 performs processing as described below.

The transition information generation unit 132 first performs processing described hereinafter using a failure condition FS (specifically, Eqn. 8), which is associated with a transition to a specific system state that takes place at a specific transition rate as, in the recovery information 502, as a processing target. Next, the transition information generation unit 132 calculates at least one or more system failure states that satisfy the failure condition FS, which is used as a processing target, and, in accordance with a calculation formula exemplified in Eqn. 11, calculates an index in the matrix R corresponding to the calculated system failure state with respect to each of the system failure states. With respect to each of the rows specified by the indices indicating the calculated system failure states, the transition information generation unit 132 calculates a value indicating the specific transition rate a_{S} as a value at a column that is associated so as to correspond to a system state to which a recovery from the system failure state takes place. With respect to each (I, J) element in the matrix Q exemplified in FIG. 16, when I and J are different from each other, the transition information generation unit 132 calculates a_{S} a transition rate for a transition from a single failure state, that collectively summarizes the system failure states, to the specific system state and calculates out 0 as a transition rate for a transition from the system failure states to a state other than the specific system state. When I and J coincide with each other, the transition information generation unit 132 calculates a value in accordance with the above-described Eqn. 1.

Therefore, with regard to system failure states, a row and a column into which a plurality of rows and a plurality of columns representing the system failure states that are processed collectively as a single system failure state are combined, respectively, in the matrix R correspond to a row and a column in the matrix Q. As a result, the number of rows and the number of columns of the matrix Q are smaller than the number of rows and the number of columns of the matrix R. In the processing of combining system failure states into a single system failure state, when a set of “system failure states that are processed collectively as a single system failure state” is given attention, the number of reductions in the number of rows composing the matrix Q or the number of reductions in the number of columns composing the matrix Q is a number indicated by the number A below. That is,
the number A: “(the number of system failure states composing the system failure states that are processed collectively as a single system failure state)−1”.

In the processing of combining system failure states into a single system failure state, the number of reduction for all sets of “system failure states that are processed collectively as a single system failure state” is, with respect to each of the rows and the columns, the total sum of the above-described numbers A for the respective sets of “system failure states that are processed collectively as a single system failure state”. For example, the number of system failure states calculated in accordance with Eqn. 8 is 3, as described later (that is, the fourth, sixth, and seventh rows of the matrix R), and the number of system failure states calculated in accordance with Eqn. 7 is 4 (that is, the eighth to eleventh rows of the matrix R). Therefore, comparison between the matrix Q exemplified in FIG. 16 and the matrix R exemplified in FIG. 15 results that each of the number of rows and the number of columns reduces by 5 (=(3−1)+(4−1)).

The transition information generation unit 132 calculates a transition rate representing the above-described sum by adding up transition rates at respective columns specified by indices indicating the system failure states into a sum with respect to a row specified by an index indicating the system operation state, out of indices that the transition information generation unit 132 has calculated in accordance with the above-described processing.

Next, among processing of calculating the matrix Q from the matrix R, processing with respect to rows representing system operation states will be described. For convenience of description, it is assumed that a set of indices in the matrix R corresponding to an index J (that is, a J-th state) in the matrix Q is denoted by G(J). For example, with respect to the fourth state indicating the single system failure state into which system failure states are combined in FIG. 16, a set G(4) of indices in the matrix illustrated in FIG. 15 is made up of three elements {4, 6, 7} indicating system failure states that are combined into the single system failure state. Such three elements are values “4”, “6”, and “7” of indices that were obtained above in accordance with Eqn. 11.

For convenience of description, it is assumed that, with respect to system operation states, indices calculated in accordance with Eqn. 11 have the same values in the matrix R exemplified in FIG. 15 and in the matrix Q exemplified in FIG. 16. That is, it is assumed that, with respect to an index J that indicates a system operation state, G(J) is made up of one element {J}. As long as respective indices of the matrix R and respective indices of the matrix Q are associated with each other, the indices are not limited to the above-described example.

When, with respect to an (I, J) element of the matrix Q exemplified in FIG. 16, I and J are different from each other and a system state indicated by a J-th column is the system failure state into which a plurality of system failure states are combined for collective processing, the transition information generation unit 132 calculates a transition rate in accordance with Eqn. 14.

Q(I,J)=Σ_{(KεG(J))}R(I,K) (Eqn. 14),
(where Σ_{(KεG(J))} denotes that the total sum is taken over the elements K included in a set G(J) of indices).

When, with respect to a row that an index indicating the system operation state specifies, I and J coincides with each other, the transition information generation unit 132 calculates a value in accordance with the above-described Eqn. 1.

Therefore, since associations are defined so that a set G(J) of indices corresponds to a plurality of indices in the matrix R with respect to a system operation state(s), performing the above-described processing reduces the number of columns of the matrix Q in comparison with the number of columns of the matrix R. On the other hand, since the number of indices indicating system operation states in the matrix Q is the same as the number of indices indicating system operation states in the matrix R, the number of rows in the matrix Q is the same as the number of rows in the matrix R with respect to a system operation state(s). That is, in processing related to a system operation state(s), the number of reductions in the number of columns composing the matrix Q is the total sum of the above-described numbers A for the respective sets of “system failure states that are processed collectively as a single system failure state”. On the other hand, when a system operation state(s) is/are given attention, the number of rows in the matrix Q is the same as the number of rows in the matrix R. For example, the number of system failure states that is calculated in accordance with Eqn. 8 is 3 (that is, the fourth, sixth, and seventh rows in the matrix R), which will be described later, and the number of system failure states that is calculated in accordance with Eqn. 7 is 4 (that is, the eighth to eleventh rows in the matrix R). Therefore, it is shown that the number of columns reduces by 5 (=(3−1)+(4−1)) by comparing between the matrix Q exemplified in FIG. 16 and the matrix R exemplified in FIG. 15 results.

In a similar manner to the above-described series of processing related to the recovery information 502 including the failure condition FS, the transition information generation unit 132, with respect to information (the recovery information 502 including the failure condition FC) as shown in Eqn. 9, calculates system failure states satisfying the failure condition FC on the basis of the failure condition FC exemplified in Eqn. 7. Next, the transition information generation unit 132 obtains indices for the calculated system failure states in accordance with Eqn. 11, and processes system failure states represented by the eighth, ninth, tenth, and eleventh rows in the matrix R, which are indicated by the obtained indices, collectively as a single system failure state. A detailed description of the processing related to the failure condition FC will be omitted.

An index J indicating a system operation state in the matrix Q is associated with an index that indicates a system operation state in the matrix R by means of the above-described set G(J) of indices. On the other hand, an index J indicating a system failure state in the matrix Q is associated with a plurality of indices that indicate the system failure states that are combined into the single system failure state by using the above-described set G(J) of indices.

That is, with respect to system failure states, the number of rows and the number of columns in the matrix Q (FIG. 16), which is a result of the above-described processing, are smaller than the number of rows and the number of columns in the matrix R (FIG. 15), respectively. With respect to a system operation state(s), the number of columns in the matrix Q, which is a result of the above-described processing, is smaller than the number of columns in the matrix R. Thus, the size of the matrix Q is smaller than the size of the matrix R. As described at the beginning of “Description of Embodiments” before the description of the respective example embodiments, the matrix Q is a square matrix. Thus, a relation such that the number of reductions in the number of columns of the matrix Q because of the processing with respect to system failure states is equal to the number of reductions in the number of rows of the matrix Q is maintained. That is, comparing the matrix R with the matrix Q, which is a result of the above-described processing, results that the number of reductions in the number of columns composing the matrix Q is equal to the number of reductions in the number of rows composing the matrix Q. However, in the present invention, the method for determining the number of columns is not limited to the method that uses characteristics of a square matrix in the example embodiment.

In the following description, the above-described processing procedure will be described more specifically, using a case illustrated in FIGS. 15 and 16 as an example. With respect to information as shown in Eqn. 10 (the recovery information 502 including the failure condition FS), the transition information generation unit 132 processes system failure states represented by the fourth, sixth, and seventh rows in FIG. 15 as a single system failure state.

For example, in the matrix R exemplified in FIG. 15, values at the fourth column and the sixth columns in the second row are λ_{d}. Since, as described afore with regard to a continuous time Markov chain at the beginning of the example embodiment, an element at an I-th row and J-th column of the matrix R represents a transition rate for a transition from the I-th state to the J-th state, a transition rate for a transition from a system operation state represented by the second row to a system failure state represented by the fourth column is λ_{d}. Similarly, a transition rate for a transition from the system operation state represented by the second row of the matrix R to a system failure state represented by the sixth column thereof is λ_{d}. That is, the calculation unit 113 calculates λ_{d} as a value in the case of transitioning from the system operation state represented by the second row of the matrix R to the system failure state represented by the fourth column thereof. A transition rate for a transition from the system operation state represented by the second row of the matrix R to a system failure state represented by the seventh column thereof is 0.

In the afore-described example related to a transition rate as, the transition information generation unit 132 processes the system failure states represented by the fourth row, the sixth row, and the seventh row of the matrix R as system failure states that are processed collectively as a single system failure state instead of the individual system failures. That is, the transition information generation unit 132 calculates a transition rate for a transition from the system operation state represented by the second row of the matrix R to the single system failure state as the sum of the above-described three transition rates. For example, the transition information generation unit 132 receives values (in this case, 0 and two λ_{d}) for respective three transition rates corresponding to the three rows being given attention, which were described in the preceding paragraph, from the calculation unit 113, and calculates the sum of the three values (in this case, λ_{d}+λ_{d}+0). That is, the three values are, in FIG. 15,
a transition rate λ_{d} for a transition from the system operation state represented by the second row to the system failure state represented by the fourth column,
a transition rate λ_{d} for a transition from the system operation state represented by the second row to the system failure state represented by the sixth column, and
a transition rate “0” for a transition from the system operation state represented by the second row to the system failure state represented by the seventh column.

Hereinafter, processing performed with respect to each row of the matrix R will be described specifically. The transition information generation unit 132 calculates a transition rate for a transition from the system operation state represented by the second row of the matrix R, which is exemplified in FIG. 15, to any of the system failure states that are processed collectively as the single system failure state as 2×λ_{d} (=λ_{d}+λ_{d}+0). The calculated value (2×λ_{d}) is represented in a single value that represents the system failure states represented by the three rows being given attention and is set to the fourth column in the second row of the matrix Q. That is because the second row of the matrix Q represents a system operation state indicated by a set G(2) of indices, and the fourth row of the matrix Q represents system failure states indicated by a set G(4) of indices.

Similarly, the transition information generation unit 132, with respect to the system operation state represented by the third row of the matrix R exemplified in FIG. 15, processes the system failure states represented by the fourth row, the sixth row, and the seventh row as system failure states that are processed collectively as a single system failure state instead of the individual system failure states. Thus, the transition information generation unit 132 calculates a transition rate for a transition from the system operation state represented by the third row of the matrix R exemplified in FIG. 15 to the single system failure state as the sum of three transition rates, which will be described below. That is, the three transition rates are, in FIG. 15,
a transition rate λ_{d} for a transition from the system operation state represented by the third row to the system failure state represented by the fourth column,
a transition rate “0” for a transition from the system operation state represented by the third row to the system failure state represented by the sixth column, and
a transition rate λ_{d} for a transition from the system operation state represented by the third row to the system failure state represented by the seventh column.

The transition information generation unit 132 calculates a transition rate for a transition from the system operation state represented by the third row in FIG. 15 to any of the system failure states that are processed collectively as the single system failure state as the sum of the above-described three transition rates.

That is, the transition information generation unit 132 calculates a transition rate for a transition from the system operation state represented by the third row of the matrix Q exemplified in FIG. 16 to any of the system failure states that are processed collectively as the single system failure state as 2×λ_{d} (=λ_{d}+0+λ_{d}). The above-described transition rate is a value calculated by the calculation unit 113. The calculated value (2×λ_{d}) is represented in a single value that represents the system failure states corresponding to the three rows being given attention and is set to the fourth column in the third row of the matrix Q. That is because the third row of the matrix Q represents a system operation state indicated by a set G(3) of indices, and the fourth row of the matrix Q represents system failure states indicated by a set G(4) of indices.

Further, similarly, the transition information generation unit 132, with respect to the system operation state represented by the first row of the matrix R exemplified in FIG. 15, processes the system failure states represented by the fourth row, the sixth row, and the seventh row as system failure states that are processed collectively as a single system failure state instead of these individual system failure states. Thus, the transition information generation unit 132 calculates a transition rate for a transition from the system operation state represented by the first row of the matrix R exemplified in FIG. 15 to the single system failure state by adding the following three transition rates. That is, the three transition rates are, in FIG. 15,
a transition rate “0” for a transition from the system operation state represented by the first row to the system failure state represented by the fourth column,
a transition rate “0” for a transition from the system operation state represented by the first row to the system failure state represented by the sixth column, and
a transition rate “0” for a transition from the system operation state represented by the first row to the system failure state represented by the seventh column.

That is, the transition information generation unit 132 calculates a transition rate for a transition from the system operation state represented by the first row of the matrix Q exemplified in FIG. 16 to the single system failure state as the sum of the above-described three transition rates. The transition information generation unit 132 calculates a transition rate for a transition from the system operation state represented by the first row of the matrix Q exemplified in FIG. 16 to the single system failure state as 0 (=0+0+0). The above-described transition rate is a value calculated by the calculation unit 113. The calculated value (0) is represented in a single value that represents system failure states corresponding to the three rows being given attention, and is set to the fourth column in the first row of the matrix Q. That is because the first row of the matrix Q represents a system operation state indicated by a set G(1) of indices, and the fourth row of the matrix Q represents system failure states indicated by a set G(4) of indices.

In a similar manner to the above-described series of processing related to the transition rate as, processing is also performed for the system failure states that are represented by the eighth to eleventh rows of the matrix R and associated with a transition rate a_{C} and the system operation state represented by the fifth row of the matrix R. A detailed description of a processing procedure that is performed targeting such rows related to the transition rate a_{C} will be omitted.

By the transition information generation unit 132 described thus far, the matrix R exemplified in FIG. 15 is changed into the matrix Q exemplified in FIG. 16. In this case, the analysis unit 124, referring to the matrix Q in the storage devices, updates the numerical string π^{(k)}. Therefore, in the processing of the analysis unit 124 updating the numerical string π^{(k)}, the calculation unit 113 no longer has to calculate elements included in the matrix Q repeatedly.

Next, an advantageous effect of the availability analysis device 133 according to the fourth example embodiment will be described.

The availability analysis device 133 according to the example embodiment further makes it possible to calculate availability for a large-scale target system in addition to the advantageous effect obtained by the availability analysis device 123 according to the third example embodiment.

The reason for the advantageous effect is the following reasons 1 and 2:

(Reason 1) the configuration of the availability analysis device 133 according to the fourth example embodiment contains the configuration of the availability analysis device 123 according to the third example embodiment; and

(Reason 2) processing a plurality of system failure states as a single system failure state reduces the size of the matrix Q in comparison with the availability analysis device 123 according to the third example embodiment.

### Fifth Example Embodiment

Next, a fifth example embodiment of the present invention, which is used as a base in configuring the above-described respective example embodiments of the present invention, will be described.

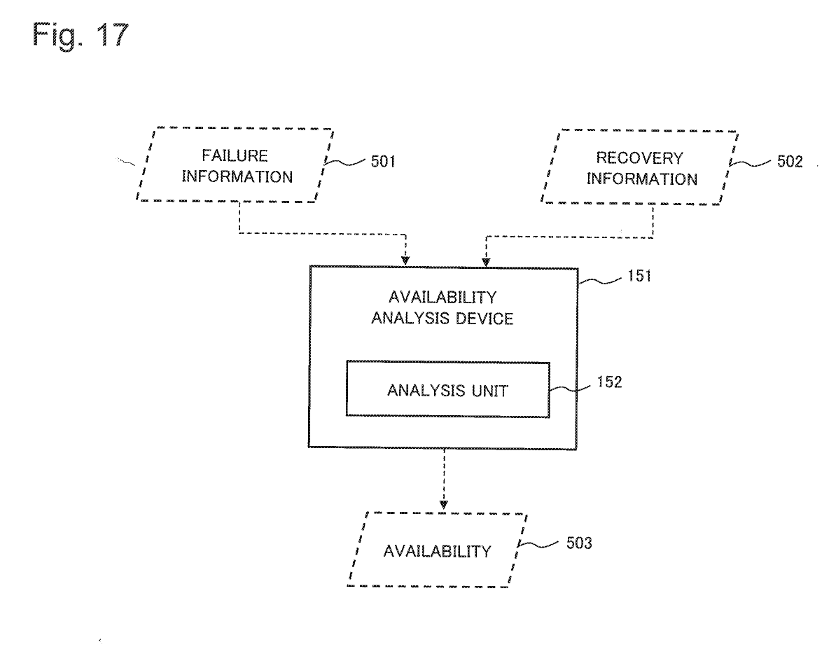

With reference to FIG. 17, a configuration that the availability analysis device 101 according to the first example embodiment of the present invention has will be described in detail. FIG. 17 is a block diagram illustrating a configuration of an availability analysis device 151 according to the fifth example embodiment of the present invention.

The availability analysis device 151 of the fifth example embodiment includes an analysis unit 152.

The analysis unit 152 calculates a values representing each relation between two system states out of a plurality of system states that a target system is able to take, on the basis of the following three types of information. That is, the three types of information are:
(1) component information representing transition rates between component states of each component included in the target system;
(2) failure information including a condition for component states of the components under system failure states of the target system out of a plurality of system states that the target system is able to take. The system failure states represent that the target system is unable to operate; and
(3) recovery information including a transition rate for transitions from a system failure state of the target system to a system operation state. The system operation represents that the target system is in operation.

The processing of calculating a value defined for each relation between two system states is a process similar to the processing in the calculation unit 102 described in the first example embodiment, the calculation unit 113 described in the second, third, and fourth example embodiments, or the like.

Next, the analysis unit 152 calculates a probability that the target system is in each system state on the basis of the calculated value defined for each relation between two system states.

The analysis unit 152 calculates availability of the target system on the basis of a probability(ies) that the target system is in the system operation state(s) out of the calculated transition rates. For example, the analysis unit 152 calculates availability by adding up the probabilities that the target system is in the system operation states.

The processing of calculating transition rates and the processing of calculating availability are processing similar to the processing in the analysis unit 103 described in the first and second example embodiments, the analysis unit 124 described in the third and fourth example embodiments, and the like.

Next, an advantageous effect of the availability analysis device 151 according to the fifth example embodiment will be described.

The availability analysis device 151 according to the fifth example embodiment makes it possible to analyze availability of a target system even when its scale is large. That is because it is not required to store all the elements of a matrix that represents transitions from first system states to second system states.

### Hardware Configuration Example

A configuration example of hardware resources that realize an availability analysis device in the above-described example embodiments of the present invention using a single calculation processing apparatus (an information processing apparatus or a computer) will be described. However, the availability analysis device may be realized using physically or functionally at least two calculation processing apparatuses. Further, the availability analysis device may be realized as a dedicated apparatus.

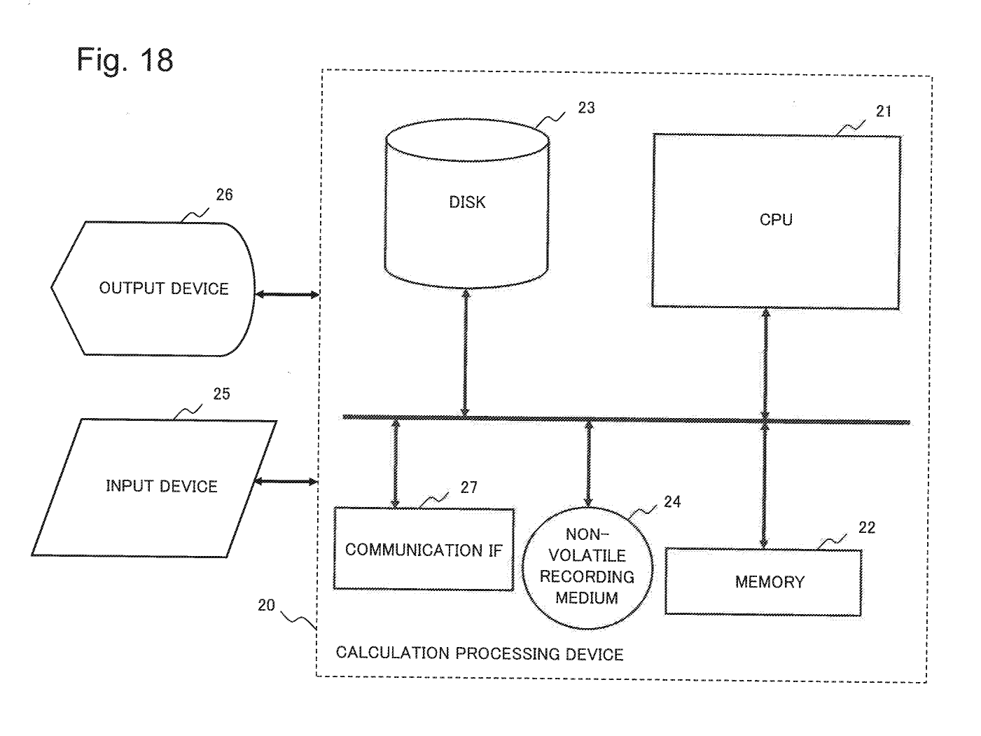

FIG. 18 is a block diagram schematically illustrating a hardware configuration of a calculation processing apparatus capable of realizing the availability analysis device according to each of the first example embodiment to the five example embodiment. A calculation processing apparatus 20 includes a central processing unit (CPU) 21, a memory 22, a disc 23, a non-transitory recording medium 24, an input apparatus 25, an output apparatus 26, and a communication interface (hereinafter, expressed as a “communication I/F”) 27. The calculation processing apparatus 20 can execute transmission/reception of information to/from another calculation processing apparatus and a communication apparatus via the communication I/F 27.

The non-transitory recording medium 24 is, for example, a computer-readable Compact Disc, Digital_Versatile_Disc. The non-transitory recording medium 24 is, for example, Universal Serial Bus (USB) memory, or Solid State Drive. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory medium 24.

In other words, the CPU 21 copies, on the memory 22, a software program (a computer program: hereinafter, referred to simply as a “program”) stored by the disc 23 when executing the program and executes arithmetic processing. The CPU 21 reads data necessary for program execution from the memory 22. When display is needed, the CPU 21 displays an output result on the output apparatus 26. When a program is input from the outside, the CPU 21 reads the program from the input apparatus 25. The CPU 21 interprets and executes an availability analysis program present on the memory 22 corresponding to a function (processing) indicated by each unit illustrated in FIG. 1, FIG. 6, FIG. 9, FIG. 11, or FIG. 17 described above or an availability analysis calculation program (FIG. 2, FIG. 3, FIG. 4, FIG. 7, FIG. 8, or FIG. 10). The CPU 21 sequentially executes the processing described in each example embodiment of the present invention.

In other words, in such a case, it is conceivable that the present invention can also be made using the availability analysis program. Further, it is conceivable that the present invention can also be made using a computer-readable, non-transitory recording medium storing the availability analysis program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2014-084087, filed on Apr. 16, 2014, the disclosure of which is incorporated herein in its entirety.

### REFERENCE SINGS LIST

101 Availability analysis device
102 Calculation unit
103 Analysis unit
104 Input unit
501 Failure information
502 Recovery information
503 Availability
111 Availability analysis device
112 Input unit
113 Calculation unit
114 Generation unit
121 Determination unit
122 Transition information generation unit
123 Availability analysis device
124 Analysis unit
131 Determination unit
132 Transition information generation unit
133 Availability analysis device
151 Availability analysis device
152 Analysis unit
521 Host computer
522 Storage system
523 Backup system
524 RAID controller
525 Storage device
526 Storage device
527 Storage device
528 Storage device
20 Calculation processing device
21 CPU
22 Memory
23 Disk
24 Non-volatile recording medium
25 Input device
26 Output device
27 Communication IF

What is claimed is:

1. An availability analysis device:
configured to calculate, on basis of (I) component information representing transition rates for transition between states of each component included in a target system, (II) failure information including a condition prescribing failure states of the components in a case in which the target system is in a failure state out of a plurality of states of the target system, the failure state indicating that the target system is unable to operate, and (III) recovery information including a transition rate at which the target system transitions from the failure state to an operation state, the operation state indicating that the target system is in operation, a value related to a relation between two states included in the plurality of states,
calculate, on basis of the value related to the relation between two states thus calculated, a probability that the target system is in one of the plurality of states, and
calculate, on basis of the probability that the target system is in the operation state, availability of the target system.

2. The availability analysis device according to claim 1, wherein
the value related to the relation between two states is a value representing a transition from a state identified by a first state identifier to a state identified by a second state identifier, and
in calculating the availability, calculating the value on basis of the component information when the first state identifier is not included in the failure information in which a third state identifier identifying the failure state and the condition are associated with each other.

3. The availability analysis device according to claim 2, wherein, in calculating the availability,
(a) in the recovery information in which the third state identifier, a fourth state identifier identifying the operation state to which a transition from the failure state identified by the third state identifier takes place, and the transition rate are associated with one another, when the first state identifier and the second state identifier are associated with each other, calculating the transition rate associated with the first state identifier and the second state identifier as the value,
(b) when the first state identifier is included in the failure states, and the first state identifier and the second state identifier coincide with each other, calculating the transition rate associated with the first state identifier in the recovery information multiplied by −1 as the value, and
(c) when the first state identifier is included in the failure states and neither the item (a) nor the item (b) holds, calculating 0 as the value.

4. The availability analysis device according to claim 1, wherein, in calculating the availability,
when the first state identifier or the second state identifier is included in non-reachability information including a state identifier identifying a state that the target system is unable to take, calculating 0 as the value, and, when the non-reachability information includes none of the state identifiers, calculating the value on basis of the items (I), (II), and (III).

5. The availability analysis device according to claim 1, further comprising:
a determination unit configured to determine whether or not the number of state identifiers included in reachability information, that includes state identifiers identifying reachable states representing states that the target system is able to take, is less than or equal to a predetermined number; and
a generation unit configured to, when the number of state identifiers included in the reachability information is less than or equal to the predetermined number, generate transition information including the value calculated with respect to the reachable state,
wherein calculating the availability on basis of the transition information.

6. The availability analysis device according to claim 5, wherein
the determination unit calculates the number of the state identifiers by setting failure states as a single state among state identifiers included in the reachability information, and determines whether or not the number of state identifiers thus calculated is less than or equal to the predetermined number, and
the generation unit generates the transition information by treating the failure states as a single state.

7. An availability analysis method comprising:
calculating, on basis of (I) component information representing transition rates for transition between states of each component included in a target system, (II) failure information including a condition prescribing failure states of the components in a case in which the target system is in a failure state out of a plurality of states of the target system, the failure state indicating that the target system is unable to operate, and (III) recovery information including a transition rate at which the target system transitions from the failure state to an operation state, the operation state indicating that the target system is in operation, a value related to a relation between two states included in the plurality of states, calculating, on basis of the value related to the relation between two states thus calculated, a probability that the target system is in one of the plurality of states, and calculating, on basis of the probability that the target system is in the operation state, availability of the target system.

8. A non-transitory recording medium having an availability analysis program recorded therein, the program making a computer achieve:
an analysis function configured to calculate, on basis of (I) component information representing transition rates for transition between states of each component included in a target system, (II) failure information including a condition prescribing failure states of the components in a case in which the target system is in a failure state out of a plurality of states of the target system, the failure state indicating that the target system is unable to operate, and (III) recovery information including a transition rate at which the target system transitions from the failure state to an operation state, the operation state indicating that the target system is in operation, a value related to a relation between two states included in the plurality of states, calculate, on basis of the value related to the relation between two states thus calculated, a probability that the target system is in one of the plurality of states, and calculate, on basis of the probability that the target system is in the operation state, availability of the target system.

9. The non-transitory recording medium having an availability analysis program recorded therein according to claim 8, wherein
the value related to the relation between two states is a value representing a transition from a state identified by a first state identifier to a state identified by a second state identifier, and
the analysis function calculates the value on basis of the component information when the first state identifier is not included in the failure information in which a third state identifier identifying the failure state and the condition are associated with each other.

10. The non-transitory recording medium having an availability analysis program recorded therein according to claim 9, wherein
the analysis function,
(a) in the recovery information in which the third state identifier, a fourth state identifier identifying the operation state to which a transition from the failure state identified by the third state identifier takes place, and the transition rate are associated with one another, when the first state identifier and the second state identifier are associated with each other, calculates the transition rate associated with the first state identifier and the second state identifier as the value,
(b) when the first state identifier is included in the failure states, and the first state identifier and the second state identifier coincide with each other, calculates the transition rate associated with the first state identifier in the recovery information multiplied by −1 as the value, and
(c) when the first state identifier is included in the failure states and neither the item (a) nor the item (b) holds, calculates 0 as the value.
